(19) United States
(12) Patent Application Publication
(10) Pub. No.: US 2026/0040397 A1
(43) Pub. Date: Feb. 5, 2026

(54) METHOD AND APPARATUS FOR CONTROLLING DISCONTINUOUS TRANSMISSION OF BEAM IN WIRELESS COMMUNICATION SYSTEM

(71) Applicant: Electronics and Telecommunications Research Institute, Daejeon (KR)

(72) Inventors: Jisoo PARK, Daejeon (KR); Seungkwon CHO, Daejeon (KR)

(21) Appl. No.: 19/290,245

(22) Filed: Aug. 4, 2025

(30) Foreign Application Priority Data
Aug. 5, 2024 (KR) 10-2024-0103978
Aug. 1, 2025 (KR) 10-2025-0106046

(51) Int. Cl. H04W 76/28

(52) U.S. Cl. CPC H04W 76/28

(57) ABSTRACT

A method of a UE may comprise: receiving beam DTX group configuration information from a base station through a first beam or a second beam; monitoring reception of first beam DTX group control information indicating beam DTX activation for at least one beam of the first beam or the second beam based on the beam DTX group configuration information; determining whether beam DTX activation for the first beam is indicated based on reception of the first beam DTX group control information; and performing discontinuous reception of DL wireless signals from the base station through the first beam, based on the beam DTX activation being indicated for the first beam.

### CROSS-REFERENCE TO RELATED APPLICATIONS

This application claims priority to Korean Patent Applications No. 10-2024-0103978, filed on Aug. 5, 2024, and No. 10-2025-0106046, filed on Aug. 1, 2025, with the Korean Intellectual Property Office (KIPO), the entire contents of which are hereby incorporated by reference.

### BACKGROUND

### 1. Technical Field

The present disclosure relates to a technique for controlling beam transmission in a wireless communication system, and more particularly, to a technique for controlling discontinuous transmission of a beam in a wireless communication system.

### 2. Related Art

With the development of information and communication technology, various wireless communication technologies have been developed. Typical wireless communication technologies include long term evolution (LTE), new radio (NR), 6th generation (6G) communication, and/or the like. The LTE may be one of 4th generation (4G) wireless communication technologies, and the NR may be one of 5th generation (5G) wireless communication technologies.

After the commercialization of the fourth-generation (4G) communication system (e.g. communication system supporting LTE), a fifth-generation (5G) communication system (e.g. communication system supporting NR) using not only a frequency band of the 4G communication system (e.g. frequency band below 6 GHz) but also a higher frequency band than the frequency band of the 4G communication system (e.g. frequency band above 6 GHZ) is being considered in order to handle the rapid increase in wireless data. The next-generation communication system aims not only to improve services and performance of previous generations but also to realize new services, and can support enhanced Mobile Broadband (eMBB), Ultra-Reliable and Low Latency Communication (URLLC), and massive Machine Type Communication (mMTC) services.

Wireless communication technologies for supporting advanced next-generation 5G, 5G-Advanced, and 6G services include beamforming technology utilizing advanced smart antenna technology and massive multiple input multiple output (mMIMO) technology, as well as accommodation of various radio frame structures, system transmission specifications of various numerology types, definitions of uplink and downlink physical channels, various types and utilization of reference signals, and reporting of wireless channel states. The usage of such technologies is being diversified and further developed.

The beamforming technology has been presented as one of various schemes for meeting the demand for high-speed data transmission in a communication system. Beamforming is a technology that transmits signal energy through multiple antennas intensively in a specific direction and enables transmission of signals with maximum power in a desired direction by controlling the power or phase supplied to the antennas.

An increase in network capacity to meet the demand for high-speed data transmission, together with the deployment of more base stations applying beamforming antenna technology, results in higher power consumption for wireless signal transmission. Due to the increase in network power consumption, one of the core requirements of next-generation communication technologies is improving network energy efficiency and ensuring efficient utilization of transmission energy.

Therefore, methods and apparatuses capable of reducing network energy consumption in a wireless communication system are required.

### SUMMARY

The present disclosure for resolving the above-described problems is directed to providing methods and apparatuses for controlling discontinuous beam transmission which can reduce network energy consumption in a wireless communication system.

A method of a user equipment (UE) according to an exemplary embodiment of the present disclosure may comprise: receiving beam discontinuous transmission (DTX) group configuration information from a base station through a first beam or a second beam; monitoring reception of first beam DTX group control information indicating beam DTX activation for at least one beam of the first beam or the second beam based on the beam DTX group configuration information; determining whether beam DTX activation for the first beam is indicated based on reception of the first beam DTX group control information; and performing discontinuous reception of downlink (DL) wireless signals from the base station through the first beam, based on the beam DTX activation being indicated for the first beam, wherein the DL wireless signals may include at least one of: a first physical downlink control channel (PDCCH), a first physical downlink shared channel (PDSCH), a reference signal (RS), or a synchronization signal (SS).

The beam DTX group configuration information may include at least one of: beam group information for each of one or more beam groups, a common beam group-radio network temporary identifier (RNTI) for all beam groups, a beam group-RNTI for each of the one or more beam groups, or beam DTX time domain information.

The beam DTX activation for the first beam may be indicated by downlink control information (DCI) scrambled with one of the common beam group-RNTI or a beam group-RNTI corresponding to a beam group including the first beam.

The beam DTX activation for the first beam may be indicated through a second PDSCH indicated by DCI received through a second PDCCH, and the DCI may be received by being scrambled with one of the common beam-group RNTI or a beam group-RNTI corresponding to a beam group including the first beam.

A case in which the beam DTX activation for the first beam is indicated may correspond to a case in which the first beam DTX group control information indicates activation of a first beam group including the first beam, the first beam group being configured by the beam DTX group configuration information.

A case in which the beam DTX activation for the first beam is indicated may correspond to a case in which the first beam DTX group control information indicates activation for a first beam group including the first beam, and an identifier of the first beam is included in first beam group information on the first beam group included in the first beam DTX group control information, the first beam group being configured by the beam DTX group configuration information.

The beam DTX time domain information may be configured for each of the one or more beam groups or configured to be commonly applied to all beam groups, and the beam DTX time domain information may include at least one of: a transmission active period (TAP) in which DL wireless signals are transmitted through a beam for which beam DTX activation is indicated, a transmission non-active period (TNP) in which transmission of DL wireless signals through a beam for which beam DTX activation is indicated is stopped, a beam DTX cycle (BDC) in which the TAP and the TNP are repeated, or a beam DTX service period (BDSP) in which the BDC is repeated.

The first beam DTX group control information may include at least one of: whether to activate or deactivate beam DTX, a serving cell identifier, a number of beam groups, an indicator of beam DTX time domain information to be activated, information on one or more beam groups to perform beam DTX activation/deactivation, beam information to indicate one or more beams among beams included in each of the one or more beam groups to perform beam DTX activation/deactivation, or one or more information elements to be reconfigured among information elements included in the beam DTX group configuration information.

The method may further comprise: monitoring reception of second beam DTX group control information from the base station; determining whether beam DTX deactivation for the first beam is indicated based on reception of the second beam DTX group control information; and releasing a reception operation of DL wireless signals from the base station according to beam DTX through the first beam based on the beam DTX deactivation being indicated for the first beam.

The beam DTX deactivation for the first beam may be indicated by DCI scrambled with one of a common beam group-RNTI or a beam group-RNTI corresponding to a beam group including the first beam.

The beam DTX deactivation for the first beam may be indicated through a second PDSCH indicated by DCI received through a second PDCCH, and the DCI may be received by being scrambled with one of a common beam group-RNTI or a beam group-RNTI corresponding to a beam group including the first beam.

A method of a base station according to an exemplary embodiment of the present disclosure may comprise: transmitting beam discontinuous transmission (DTX) group configuration information for a plurality of beams to a user equipment (UE); based on beam DTX being required for one or more beam groups, transmitting, to the UE, first beam DTX group control information for controlling beam DTX activation based on the beam DTX group configuration information, each beam group including one or more beams among the plurality of beams; and performing discontinuous transmission of downlink (DL) wireless signals through each beam for which beam DTX is indicated by the first beam DTX group control information, based on the beam DTX group configuration information, wherein the beam DTX group configuration information may include at least one of: beam group information for each of the one or more beam groups, a common beam group-radio network temporary identifier (RNTI) for all beam groups, a beam group-RNTI for each of the one or more beam groups, or beam DTX time domain information, and the DL wireless signals may include at least one of: a first physical downlink control channel (PDCCH), a first physical downlink shared channel (PDSCH), a reference signal (RS), or a synchronization signal (SS).

The beam group information for each of the one or more beam groups may include at least one of: beam information for one or more beams, a beam group index, or a beam group-RNTI, and the beam information includes at least one of: a beam identifier (ID) for distinguishing a beam, information on a reference signal (RS) specifying the beam, or transmission configuration indicator (TCI) information representing channel characteristics of the beam.

The beam DTX time domain information may be configured for each of the one or more beam groups or configured to be commonly applied to all beam groups, and the beam DTX time domain information may include at least one of: a transmission active period (TAP) in which DL wireless signals are transmitted through a beam for which beam DTX activation is indicated, a transmission non-active period (TNP) in which transmission of DL wireless signals through a beam for which beam DTX activation is indicated is stopped, a beam DTX cycle (BDC) in which the TAP and the TNP are repeated, or a beam DTX service period (BDSP) in which the BDC is repeated, and wherein the first beam DTX group control information may include an indicator of beam DTX time domain information to be applied to each of the one or more beam groups or a beam for which beam DTX activation is indicated, or information elements to be reconfigured among information elements included in the beam DTX group configuration information.

The first beam DTX group control information for controlling the beam DTX activation may be transmitted to the UE through downlink control information (DCI), and the DCI may be scrambled with one of the common beam-group RNTI or the beam group-RNTI.

The first beam DTX group control information for controlling the beam DTX activation may be transmitted to the UE through a second PDSCH indicated by DCI, and the DCI may be scrambled with one of the common beam group-RNTI or the beam group-RNTI and transmitted to the UE through a second PDCCH.

The first beam DTX group control information may include at least one of: a serving cell identifier, a number of activated beam groups, information of one or more activated beam groups to perform beam DTX activation, an indicator of beam DTX time domain information, information on beam(s) to perform beam DTX activation among beams included in a beam group to be activated, or one or more information elements to be reconfigured among information elements included in the beam DTX group configuration information.

A case in which beam DTX is required for the one or more beam groups may correspond to a case of requiring at least one of energy saving of the base station, energy saving of the UE, reduction in a number of UEs in communication, reduction of traffic load, reduction of beam transmission load, or interference control with a neighbor beam.

A user equipment (UE) according to an exemplary embodiment of the present disclosure may comprise at least one processor, wherein the at least one processor may cause the UE to perform: receiving beam discontinuous transmission (DTX) group configuration information from a base station through a first beam or a second beam; monitoring reception of first beam DTX group control information indicating beam DTX activation for at least one beam of the first beam or the second beam based on the beam DTX group configuration information; determining whether beam DTX activation for the first beam is indicated based on reception of the first beam DTX group control information; and performing discontinuous reception of downlink (DL) wireless signals from the base station through the first beam, based on the beam DTX activation being indicated for the first beam, wherein the DL wireless signals may include at least one of: a first physical downlink control channel (PDCCH), a first physical downlink shared channel (PDSCH), a reference signal (RS), or a synchronization signal (SS).

The beam DTX group configuration information may include at least one of: beam group information for each of one or more beam groups, a common beam group-radio network temporary identifier (RNTI) for all beam groups, a beam group-RNTI for each of the one or more beam groups, or beam DTX time domain information.

According to exemplary embodiments of the present disclosure, a network (e.g. a base station) can activate and/or deactivate discontinuous transmission (DTX) of a specific beam group among beam groups. The beam groups may be formed by considering characteristics such as the positions of antennas of each network node (e.g. base station) for downlink radio signal transmission, the number of antenna ports, beam directions, beam widths, the number of connected UEs that can be served in a specific beam area, traffic load, and beam transmission load. In addition, the network can achieve energy savings by controlling radio signal transmission through activation and/or deactivation of beam DTX for the specific beam group. Furthermore, according to the present disclosure, the base station can reduce interference between downlink beams by scheduling the durations of beam DTX for respective neighbor beams so that they do not overlap in areas where interference occurs.

### BRIEF DESCRIPTION OF DRAWINGS

FIG. 1 is a conceptual diagram illustrating an exemplary embodiment of a communication system.

FIG. 2 is a block diagram illustrating an exemplary embodiment of a communication node constituting a communication system.

FIG. 3 is a conceptual diagram illustrating grouping of one or more beams subjected to DTX in a communication system.

FIG. 4A is a sequence chart illustrating a procedure of configuring beam DTX by configuring beam groups in a communication system.

FIG. 4B is a sequence chart illustrating a procedure of activating beam DTX for specific beam group(s) and operations when beam DTX is activated in a communication system.

FIG. 4C is a sequence chart illustrating a procedure of deactivating beam DTX for beam group(s) in a communication system.

FIG. 5 is a conceptual diagram illustrating transmission of DL wireless signals based on DTX time domain information within beam DTX group configuration information.

FIG. 6A is a conceptual diagram illustrating a configuration of a first type of beam DTX configuration information.

FIG. 6B is a conceptual diagram illustrating a configuration of a second type of beam DTX configuration information.

FIG. 6C is a conceptual diagram illustrating a configuration of a third type of beam DTX configuration information.

FIG. 6D is a conceptual diagram illustrating a configuration of a fourth type of beam DTX configuration information and cell-common DTX configuration information.

FIG. 7A is a conceptual diagram illustrating a configuration of a first type of beam DTX group control information.

FIG. 7B is a conceptual diagram illustrating a configuration of a second type of beam DTX group control information.

FIG. 8A is a conceptual diagram illustrating a first exemplary embodiment of an activation procedure of a specific beam group using beam DTX group configuration information and beam DTX group control information.

FIG. 8B is a conceptual diagram illustrating a second exemplary embodiment of an activation procedure of a specific beam group by using beam DTX group configuration information and beam DTX group control information.

FIG. 9A is a conceptual diagram illustrating a third exemplary embodiment of an activation procedure of a specific beam group by using beam DTX group configuration information and beam DTX group control information.

FIG. 9B is a conceptual diagram illustrating a fourth exemplary embodiment of an activation procedure of a specific beam group using beam DTX group configuration information and beam DTX group control information.

### DETAILED DESCRIPTION OF THE EMBODIMENTS

While the present disclosure is capable of various modifications and alternative forms, specific embodiments thereof are shown by way of example in the drawings and will herein be described in detail. It should be understood, however, that there is no intent to limit the present disclosure to the particular forms disclosed, but on the contrary, the present disclosure is to cover all modifications, equivalents, and alternatives falling within the spirit and scope of the present disclosure. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between,” “adjacent” versus “directly adjacent,” etc.).

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this present disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

A communication system to which exemplary embodiments according to the present disclosure are applied will be described. The communication system to which the exemplary embodiments according to the present disclosure are applied is not limited to the contents described below, and the exemplary embodiments according to the present disclosure may be applied to various communication systems. Here, the communication system may have the same meaning as a communication network.

Throughout the present disclosure, a network may include, for example, a wireless Internet such as wireless fidelity (WiFi), mobile Internet such as a wireless broadband Internet (WiBro) or a world interoperability for microwave access (WiMax), 2G mobile communication network such as a global system for mobile communication (GSM) or a code division multiple access (CDMA), 3G mobile communication network such as a wideband code division multiple access (WCDMA) or a CDMA2000, 3.5G mobile communication network such as a high speed downlink packet access (HSDPA) or a high speed uplink packet access (HSUPA), 4G mobile communication network such as a long term evolution (LTE) network or an LTE-Advanced network, 5G mobile communication network, 6G mobile communication network, or the like.

Throughout the present disclosure, a terminal may refer to a mobile station, mobile terminal, subscriber station, portable subscriber station, user equipment, access terminal, or the like, and may include all or a part of functions of the terminal, mobile station, mobile terminal, subscriber station, mobile subscriber station, user equipment, access terminal, or the like.

Here, a desktop computer, laptop computer, tablet PC, wireless phone, mobile phone, smart phone, smart watch, smart glass, e-book reader, portable multimedia player (PMP), portable game console, navigation device, digital camera, digital multimedia broadcasting (DMB) player, digital audio recorder, digital audio player, digital picture recorder, digital picture player, digital video recorder, digital video player, or the like having communication capability may be used as the terminal.

Throughout the present disclosure, the base station may refer to an access point, radio access station, node B (NB), evolved node B (eNB), base transceiver station, mobile multihop relay (MMR)-BS, or the like, and may include all or part of functions of the base station, access point, radio access station, NB, eNB, base transceiver station, MMR-BS, or the like. Hereinafter, preferred exemplary embodiments of the present disclosure will be described in more detail with reference to the accompanying drawings. In describing the present disclosure, in order to facilitate an overall understanding, the same reference numerals are used for the same elements in the drawings, and duplicate descriptions for the same elements are omitted.

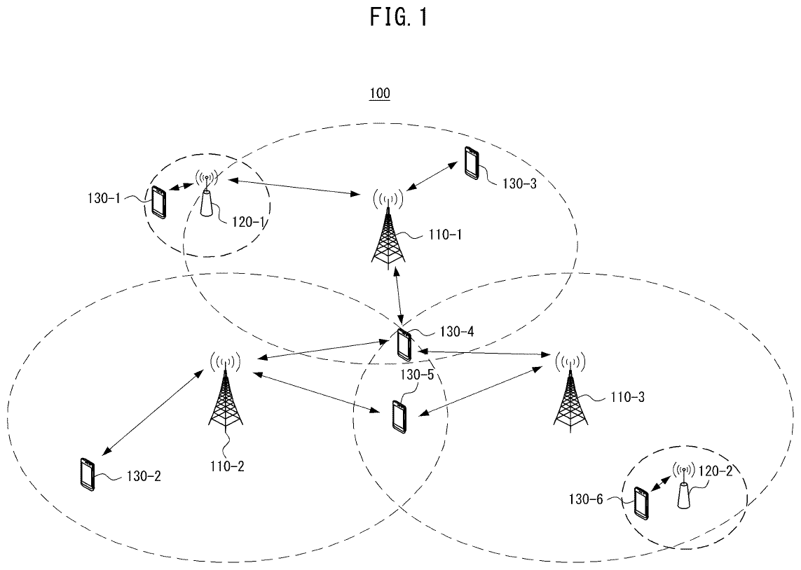

FIG. 1 is a conceptual diagram illustrating an exemplary embodiment of a communication system.

Referring to FIG. 1, a communication system 100 may comprise a plurality of communication nodes 110-1, 110-2, 110-3, 120-1, 120-2, 130-1, 130-2, 130-3, 130-4, 130-5, and 130-6. The plurality of communication nodes may support 4G communication (e.g. long term evolution (LTE), LTE-advanced (LTE-A)), 5G communication (e.g. new radio (NR)), etc. specified in the 3rd generation partnership project (3GPP) standards. The 4G communication may be performed in frequency bands below 6 GHz, and the 5G communication may be performed in frequency bands above 6 GHz as well as frequency bands below 6 GHz.

For example, in order to perform the 4G communication, 5G communication, and 6G communication, the plurality of communication may support a code division multiple access (CDMA) based communication protocol, wideband CDMA (WCDMA) based communication protocol, time division multiple access (TDMA) based communication protocol, frequency division multiple access (FDMA) based communication protocol, orthogonal frequency division multiplexing (OFDM) based communication protocol, filtered OFDM based communication protocol, cyclic prefix OFDM (CP-OFDM) based communication protocol, discrete Fourier transform spread OFDM (DFT-s-OFDM) based communication protocol, orthogonal frequency division multiple access (OFDMA) based communication protocol, single carrier FDMA (SC-FDMA) based communication protocol, non-orthogonal multiple access (NOMA) based communication protocol, generalized frequency division multiplexing (GFDM) based communication protocol, filter bank multi-carrier (FBMC) based communication protocol, universal filtered multi-carrier (UFMC) based communication protocol, space division multiple access (SDMA) based communication protocol, orthogonal time-frequency space (OTFS) based communication protocol, or the like.

Further, the communication system 100 may further include a core network. When the communication 100 supports 4G communication, the core network may include a serving gateway (S-GW), packet data network (PDN) gateway (P-GW), mobility management entity (MME), and the like. When the communication system 100 supports 5G communication or 6G communication, the core network may include a user plane function (UPF), session management function (SMF), access and mobility management function (AMF), and the like.

Meanwhile, each of the plurality of communication nodes 110-1, 110-2, 110-3, 120-1, 120-2, 130-1, 130-2, 130-3, 130-4, 130-5, and 130-6 constituting the communication system 100 may have the following structure.

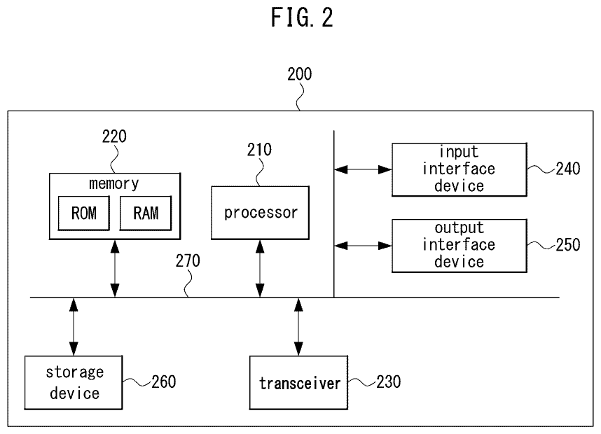

FIG. 2 is a block diagram illustrating an exemplary embodiment of a communication node constituting a communication system.

Referring to FIG. 2, a communication node 200 may comprise at least one processor 210, a memory 220, and a transceiver 230 connected to the network for performing communications. Also, the communication node 200 may further comprise an input interface device 240, an output interface device 250, a storage device 260, and the like. Each component included in the communication node 200 may communicate with each other as connected through a bus 270.

However, each component included in the communication node 200 may not be connected to the common bus 270 but may be connected to the processor 210 via an individual interface or a separate bus. For example, the processor 210 may be connected to at least one of the memory 220, the transceiver 230, the input interface device 240, the output interface device 250 and the storage device 260 via a dedicated interface.

The processor 210 may execute a program stored in at least one of the memory 220 and the storage device 260. The processor 210 may refer to a central processing unit (CPU), a graphics processing unit (GPU), or a dedicated processor on which methods in accordance with embodiments of the present disclosure are performed. Each of the memory 220 and the storage device 260 may be constituted by at least one of a volatile storage medium and a non-volatile storage medium. For example, the memory 220 may comprise at least one of read-only memory (ROM) and random access memory (RAM).

Referring again to FIG. 1, the communication system 100 may comprise a plurality of base stations 110-1, 110-2, 110-3, 120-1, and 120-2, and a plurality of terminals 130-1, 130-2, 130-3, 130-4, 130-5, and 130-6. Each of the first base station 110-1, the second base station 110-2, and the third base station 110-3 may form a macro cell, and each of the fourth base station 120-1 and the fifth base station 120-2 may form a small cell. The fourth base station 120-1, the third terminal 130-3, and the fourth terminal 130-4 may belong to cell coverage of the first base station 110-1. Also, the second terminal 130-2, the fourth terminal 130-4, and the fifth terminal 130-5 may belong to cell coverage of the second base station 110-2. Also, the fifth base station 120-2, the fourth terminal 130-4, the fifth terminal 130-5, and the sixth terminal 130-6 may belong to cell coverage of the third base station 110-3. Also, the first terminal 130-1 may belong to cell coverage of the fourth base station 120-1, and the sixth terminal 130-6 may belong to cell coverage of the fifth base station 120-2.

Here, each of the plurality of base stations 110-1, 110-2, 110-3, 120-1, and 120-2 may refer to a Node-B (NB), evolved Node-B (eNB), gNB, base transceiver station (BTS), radio base station, radio transceiver, access point, access node, road side unit (RSU), radio remote head (RRH), transmission point (TP), transmission and reception point (TRP), or the like.

Each of the plurality of terminals 130-1, 130-2, 130-3, 130-4, 130-5, and 130-6 may refer to a user equipment (UE), terminal, access terminal, mobile terminal, station, subscriber station, mobile station, portable subscriber station, node, device, Internet of Thing (IOT) device, mounted module/device/terminal, on-board device/terminal, or the like.

A base station and a UE may perform communication using an omnidirectional beam, a sector beam, or a spot beam. The omnidirectional beam may be formed using an omnidirectional antenna, and the spot beam may be formed using a beamforming antenna.

Meanwhile, each of the plurality of base stations 110-1, 110-2, 110-3, 120-1, and 120-2 may operate in the same frequency band or in different frequency bands. The plurality of base stations 110-1, 110-2, 110-3, 120-1, and 120-2 may be connected to each other via an ideal backhaul or a non-ideal backhaul, and exchange information with each other via the ideal or non-ideal backhaul. Also, each of the plurality of base stations 110-1, 110-2, 110-3, 120-1, and 120-2 may be connected to the core network through the ideal or non-ideal backhaul. Each of the plurality of base stations 110-1, 110-2, 110-3, 120-1, and 120-2 may transmit a signal received from the core network to the corresponding terminal 130-1, 130-2, 130-3, 130-4, 130-5, or 130-6, and transmit a signal received from the corresponding terminal 130-1, 130-2, 130-3, 130-4, 130-5, or 130-6 to the core network.

In addition, each of the plurality of base stations 110-1, 110-2, 110-3, 120-1, and 120-2 may support multi-input multi-output (MIMO) transmission (e.g. a single-user MIMO (SU-MIMO), multi-user MIMO (MU-MIMO), massive MIMO, or the like), coordinated multipoint (CoMP) transmission, carrier aggregation (CA) transmission, transmission in an unlicensed band, device-to-device (D2D) communications (or, proximity services (ProSe)), or the like. Here, each of the plurality of terminals 130-1, 130-2, 130-3, 130-4, 130-5, and 130-6 may perform operations corresponding to the operations of the plurality of base stations 110-1, 110-2, 110-3, 120-1, and 120-2, and operations supported by the plurality of base stations 110-1, 110-2, 110-3, 120-1, and 120-2. For example, the second base station 110-2 may transmit a signal to the fourth terminal 130-4 in the SU-MIMO manner, and the fourth terminal 130-4 may receive the signal from the second base station 110-2 in the SU-MIMO manner. Alternatively, the second base station 110-2 may transmit a signal to the fourth terminal 130-4 and fifth terminal 130-5 in the MU-MIMO manner, and the fourth terminal 130-4 and fifth terminal 130-5 may receive the signal from the second base station 110-2 in the MU-MIMO manner.

The first base station 110-1, the second base station 110-2, and the third base station 110-3 may transmit a signal to the fourth terminal 130-4 in the CoMP transmission manner, and the fourth terminal 130-4 may receive the signal from the first base station 110-1, the second base station 110-2, and the third base station 110-3 in the COMP manner. Also, each of the plurality of base stations 110-1, 110-2, 110-3, 120-1, and 120-2 may exchange signals with the corresponding terminals 130-1, 130-2, 130-3, 130-4, 130-5, or 130-6 which belongs to its cell coverage in the CA manner. Each of the base stations 110-1, 110-2, and 110-3 may control D2D communications between the fourth terminal 130-4 and the fifth terminal 130-5, and thus the fourth terminal 130-4 and the fifth terminal 130-5 may perform the D2D communications under control of the second base station 110-2 and the third base station 110-3.

Hereinafter, methods for configuring and managing radio interfaces in a communication system will be described. Even when a method (e.g. transmission or reception of a signal) performed at a first communication node among communication nodes is described, the corresponding second communication node may perform a method (e.g. reception or transmission of the signal) corresponding to the method performed at the first communication node. That is, when an operation of a terminal is described, a corresponding base station may perform an operation corresponding to the operation of the terminal. Conversely, when an operation of a base station is described, a corresponding terminal may perform an operation corresponding to the operation of the base station.

Meanwhile, in a communication system, a base station may perform all functions (e.g. remote radio transmission/reception function, baseband processing function, and the like) of a communication protocol. Alternatively, the remote radio transmission/reception function among all the functions of the communication protocol may be performed by a transmission and reception point (TRP) (e.g. flexible (f)-TRP), and the baseband processing function among all the functions of the communication protocol may be performed by a baseband unit (BBU) block. The TRP may be a remote radio head (RRH), radio unit (RU), transmission point (TP), or the like. The BBU block may include at least one BBU or at least one digital unit (DU). The BBU block may be referred to as a ‘BBU pool’, ‘centralized BBU’, or the like. The TRP may be connected to the BBU block through a wired fronthaul link or a wireless fronthaul link. The communication system composed of backhaul links and fronthaul links may be as follows. When a functional split scheme of the communication protocol is applied, the TRP may selectively perform some functions of the BBU or some functions of medium access control (MAC)/radio link control (RLC) layers.

In the present disclosure, a phrase including “when ˜” may be expressed as a phrase including “based on ˜” or a phrase including “in response to ˜”. In other words, a phrase including “when ˜” may be interpreted as being the same as or similar to a phrase including “based on ˜” or a phrase including “in response to ˜”.

Meanwhile, in order to reduce network operating costs and to reduce environmental impact as performance indicators for the development of communication systems such as 5G, 5G-Advanced, and 6G, development of various energy saving technologies is required. The network energy saving (NES) technology of 3GPP focuses on reducing the power consumption of network elements, improving network efficiency, and extending the battery life of user equipment (UE).

Energy efficiency in communication networks such as 5G, 5G-Advanced, and 6G is a key element of sustainable communication. Due to the proliferation of large-scale devices and mobile applications in communication networks such as 5G, 5G-Advanced, and 6G, the importance of energy efficiency and power control schemes in the wireless communication field is emphasized. Accordingly, improving the energy efficiency of base stations is also a key requirement for future more environmentally friendly communication systems.

According to a white paper of 5G Americas, a significant portion of energy in the current mobile network environment is consumed in the radio access network (RAN) domain, and there are also research reports that 73% of the total energy consumption in the mobile network environment occurs in the RAN.

In 5G NR Release 18 and 5G NR Release 19 of 3GPP, operations of base stations and UEs were defined in consideration of scenarios such as idle/empty states and low/medium loads of cells. Scenarios according to various loads of cells may be for schemes for energy saving from the base station side and from the UE side.

In the specifications of 5G NR, a cell discontinuous transmission/reception (cell DTX/DRX) technology is defined. In a non-active duration of DTX, a base station (e.g. gNB) may perform an operation of stopping downlink (DL) transmission, and a UE may not perform a reception operation for specific wireless signals. In a non-active duration of DRX, a UE may not perform uplink (UL) transmission, and a gNB may not perform a reception operation for UL wireless signals. By providing the non-active duration of DTX and/or the non-active duration of DRX, energy of UEs and the network can be saved.

In the cell DTX/DRX of 5G NR, in order to configure active durations of DL transmission and UL reception operations of a gNB to be the same or different, active/non-active durations for a UE may be configured as a pattern of periodic cell DTX/DRX durations. The pattern of cell DTX/DRX durations may be commonly configured for UEs having the corresponding functionality, and cell DTX and cell DRX patterns may be separately configured and activated. For a serving cell (SCell), up to two cell DTX/DRX patterns may be configured per MAC entity. When a cell DTX service function for a specific cell is configured and activated, during a non-active duration of cell DTX, a UE may not monitor a physical downlink control channel (PDCCH) or may not monitor a semi-persistent scheduling (SPS) occasion. The cell DTX service function for the specific cell may be applied only to UEs in a radio resource control (RRC) connected state (RRC_CONNECTED state), and may not affect random access procedures, synchronization signal block (SSB) transmissions, paging, and system information block (SIB) message broadcast procedures.

The cell DTX/DRX technology of 3GPP NR described above is a key element of sustainable communication technology for energy efficiency in communication networks. Particularly, in a communication network transmitting high-speed data in a high frequency band such as the 3GPP NR technology, power consumption increasingly depends on network loads, so more efficient energy saving technologies become more important along with the evolution of wireless transmission technology. Therefore, it is necessary to efficiently operate the RAN by applying the cell DTX/DRX technology.

In the present disclosure described below, operation methods of communication nodes in a communication system are described. When a method (e.g. transmission or reception of a signal) performed at a first communication node among communication nodes is described, a second communication node corresponding thereto may perform a method (e.g. reception or transmission of the signal) corresponding to the method performed at the first communication node. In other words, when operations of a UE are described, a base station corresponding thereto may perform operations corresponding to the operations of the UE. Conversely, when operations of a base station are described, a UE corresponding thereto may perform operations corresponding to the operations of the base station.

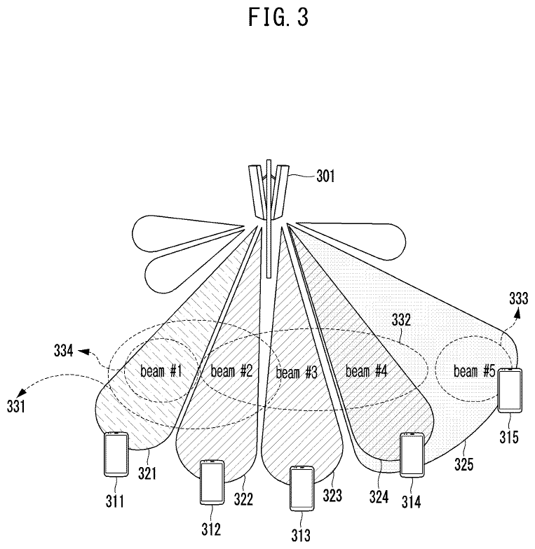

FIG. 3 is a conceptual diagram illustrating grouping of one or more beams subjected to DTX in a communication system.

Referring to FIG. 3, each of a plurality of UEs 311, 312, 313, 314, and 315 may be located within a communication area capable of communicating with a base station 301. In the example of FIG. 3, only five UEs 311 to 315 are illustrated for convenience of description, but the present disclosure is not limited thereto. The UEs 311 to 315 may each include all or part of the components of the communication node 200 described above with reference to FIG. 2. At least one of the UEs 311 to 315 may further include various user convenience devices such as cameras and sensors (e.g. altitude sensor, geomagnetic sensor, gyro sensor, etc.).

The base station 301 may include all or part of the components of the communication node 200 described above with reference to FIG. 2. The base station 301 may further include an interface for communicating with other base stations (not illustrated in FIG. 3), and an interface for communicating with an upper core network, in addition to the components illustrated in FIG. 2. The base station 301 may be configured in a form to which a functional split scheme is applied. For example, the base station 301 may be composed of a BBU block and TRP(s) described above.

The base station 301 may perform beamforming using different beams 321, 322, 323, 324, and 325 for the UEs 311 to 315. For example, the base station 301 may perform beamforming such that the beam #1 321 is directed to the UE #1 311, the beam #2 322 is directed to the UE #2 312, the beam #3 323 is directed to the UE #3 313, the beam #4 324 is directed to the UE #4 314, and the beam #5 325 is directed to the UE #4 314 and the UE #5 315. The base station 301 may transmit various signals (or data) to the UEs 311 to 315 through the respective DL beams 321 to 325 formed toward the UEs 311 to 315. For example, a PDCCH carrying system information and control information and a physical downlink shared channel (PDSCH) carrying data may be transmitted to the UEs 311 to 315 through the respective DL beams 311 to 315.

The UE #1 311 may receive signals through the beam #1 321 beamformed from the base station 301, the UE #2 312 may receive signals through the beam #2 322 beamformed from the base station 301, the UE #3 313 may receive signals through the beam #3 323 beamformed from the base station 301, the UE #4 314 may receive signals through the beam #4 324 beamformed from the base station 301 and the beam #5 325 beamformed from the base station 301, and the UE #5 315 may receive signals through the beam #5 325 beamformed from the base station 301. In the example of FIG. 3, five beams 321 to 325 formed by the base station 301 are illustrated, but the present disclosure is not limited to the number of beams that can be formed by the base station 301 being five.

In the present disclosure, the base station 301 may configure a plurality of beam groups each composed of one or more beams. According to the example of FIG. 3, a beam group #1 331 may be composed of the beam #1 321 and the beam #2 322, a beam group #2 332 may be composed of the beam #2 322, the beam #3 323, and the beam #4 324, a beam group #3 333 may be composed of the beam #5 325, and a beam group #4 334 may be composed of the beam #1 321.

As exemplified above, the beam group #1 331 and the beam group #2 332 are composed of a plurality of beams, and each of the beam group #3 333 and the beam group #4 334 may be a beam group composed of only one beam. In addition, the beam #1 321 may belong to the beam group #1 331 and simultaneously belong to the beam group #4 334, and the beam #2 322 may belong to the beam group #1 331 and simultaneously belong to the beam group #2 332.

The widths of beams that are formed by the base station 301 may be uniform or may not be uniform. In FIG. 3, the beam #1 321, the beam #2 322, the beam #3 323, and the beam #4 324 may have the same beam width, and the beam #5 325 may have a beam width wider than the other beams 321 to 324. As illustrated in FIG. 3, the beam #5 325 may have a beam width including coverage of the adjacent beam #4 324.

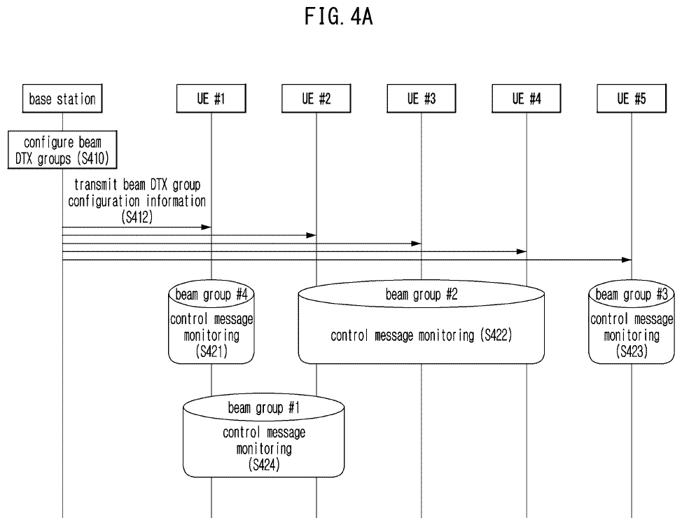

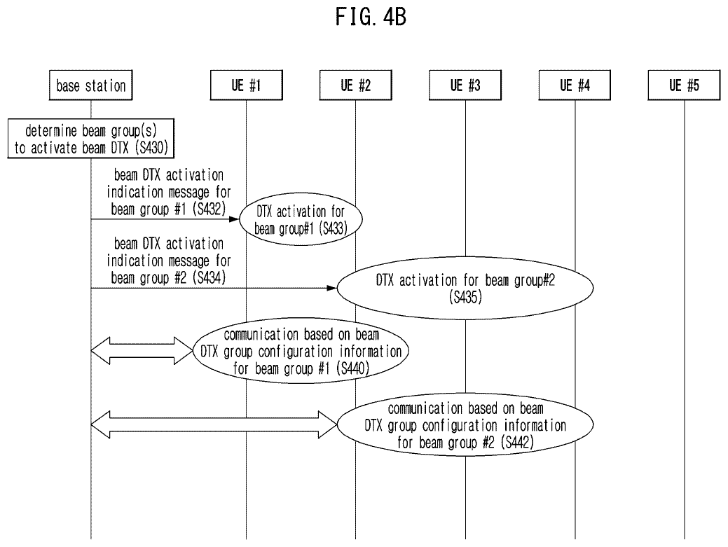

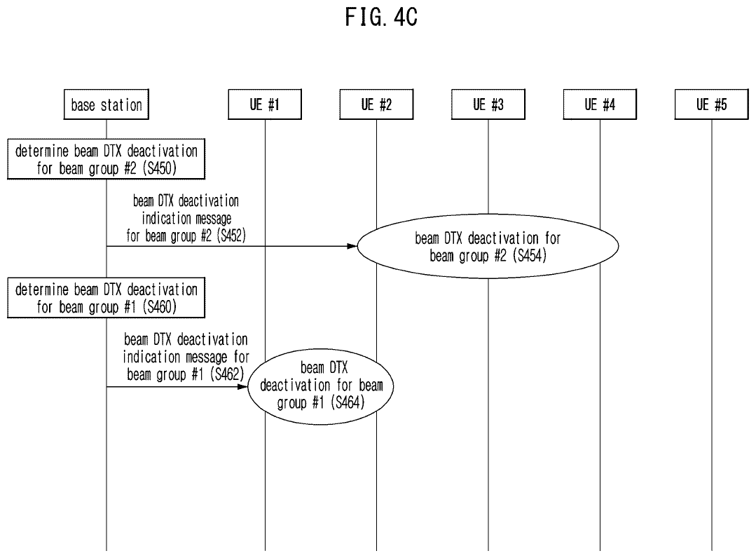

FIG. 4A is a sequence chart illustrating a procedure of configuring beam DTX by configuring beam groups in a communication system.

Before referring to FIG. 4A, it should be noted that a base station may correspond to the base station 301 described above with reference to FIG. 3, and UEs (UE #1, UE #2, UE #3, UE #4, and UE #5) may also correspond to the UEs 311 to 315 described above with reference to FIG. 3. In the following description, operations of FIG. 4A are described based on the example of FIG. 3.

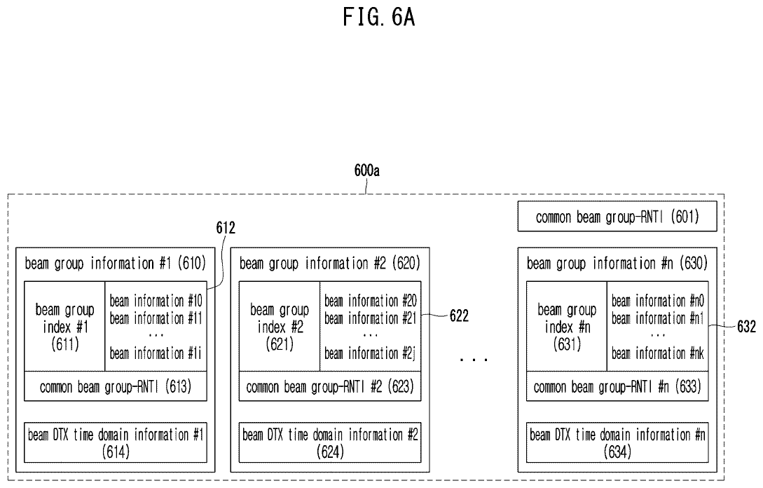

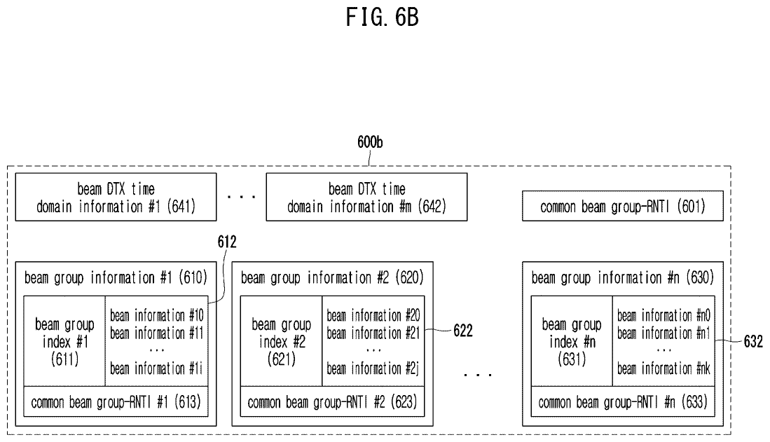

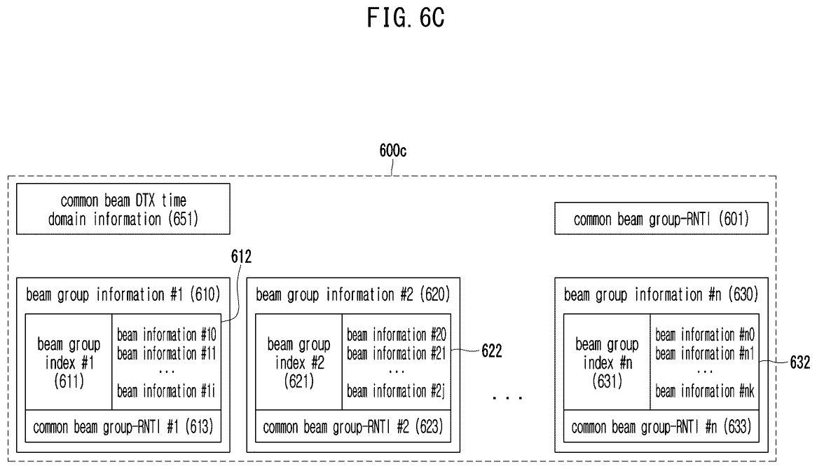

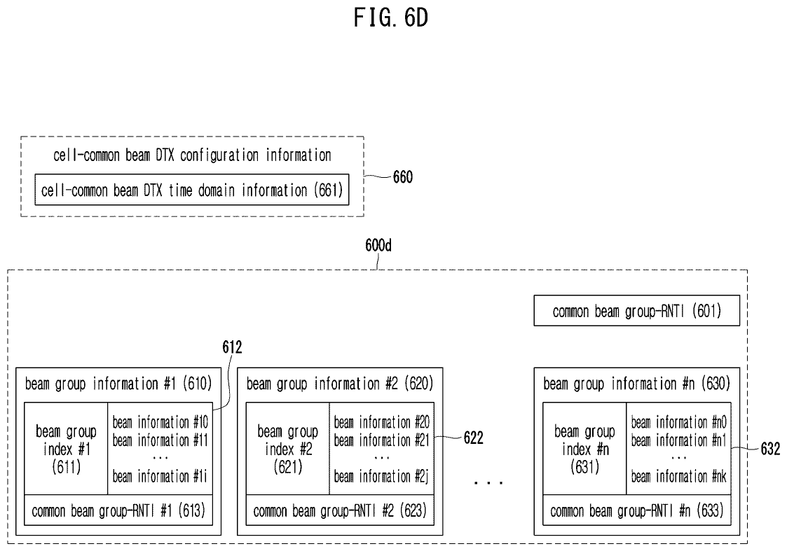

In step S410, the base station 301 may configure beam DTX groups. In describing FIG. 4A, it is assumed that each of the plurality of beam groups 331 to 334 exemplified in FIG. 3 is configured as a beam DTX group. The base station 301 may generate beam DTX group configuration information (BeamDtxGroupConfig) that includes at least one of: information on beams included in each of the beam groups, DTX-related information of each of the beam groups, or other information related to each of the beam groups. The beam DTX group configuration information is described in more detail with reference to FIGS. 6A to 6D described later.

In step S412, the base station 301 may transmit the beam DTX group configuration information (BeamDtxGroupConfig) to the UEs 311 to 315. For example, the beam DTX group configuration information may be transmitted (or broadcast) to the UEs through all beams that can be formed by the base station. In another example, the beam DTX group configuration information may be transmitted (or broadcast) through an omni beam. In another example, the beam DTX group configuration information may be transmitted (or multicast) only to communicating UEs through all beams included in each of the beam groups. In another example, in a specific case, the beam DTX group configuration information may be unicast to a specific UE. Cases where the beam DTX group configuration information is unicast to a specific UE may include a case where the UE is handed over from another base station, and/or a case where the UE transitions from an RRC inactive state (RRC_INACTIVE state) to an RRC connected state.

In the following description, for convenience of description, it is assumed that the beam DTX group configuration information is transmitted to UEs through all beams that can be formed by the base station or through all beams included in each of the beam groups as illustrated in step S412 of FIG. 4A. Therefore, the UEs 311 to 315 exemplified in FIG. 4A may be UEs communicating through beam(s) of one or more beam DTX groups. More specifically, the beam DTX group configuration information (BeamDtxGroupConfig) may be transmitted as follows.

In step S412, the base station 301 may transmit the beam DTX group configuration information to the UE #1 311 and the UE #2 312 through the beam #1 321 and the beam #2 322 of the beam group #1 331, may transmit the beam DTX group configuration information to the UE #2 312, the UE #3 313, and the UE #4 314 through the beam #2 322, the beam #3 323, and the beam #4 324 of the beam group #2 332, may transmit the beam DTX group configuration information to the UE #4 314 and the UE #5 315 through the beam #5 325 of the beam group #3 333, and may transmit the beam DTX group configuration information to the UE #1 311 through the beam #1 321 of the beam group #4 334.

Step S412 of FIG. 4A illustrates that, through the procedure described above, the beam DTX group configuration information is transmitted to each of the UEs 311 to 315. Therefore, each of the UEs 311 to 315 may receive the beam DTX group configuration information from the base station 301 through one or more beams communicating with the base station 301 in step S412.

According to an exemplary embodiment of the present disclosure, the beam DTX group configuration information may include one or more of the following information.
(A) Beam group information (BeamGroupInfo), and
(B) Beam DTX time domain information (BeamDtxTimeInfo).

The beam group information (BeamGroupInfo) may include one or more of the following information for identifying each beam and/or each beam group.
(A1) Beam information (beamInfo),
(A2) Beam group index (BeamGroupIndex),
(A3) Beam group-radio network temporary identifier (RNTI) (BeamGroup-RNTI), and
(A4) Common beam group-RNTI (CommonBeamGroup-RNTI, CBG-RNTI)

The beam information (beamInfo) may be information on a beam included in each of the beam groups. More specifically, the beam information may include a beam index for distinguishing and indicating a beam. The beam index may include one or more information elements (IEs) among a beam identifier (beam ID) for distinguishing the beam, information on a reference signal (RS) specifying the beam, or information on a transmission configuration indicator (TCI) indicating channel characteristics of the beam.

In the case of an LTE system or an NR system, the RS information may include an RS identifier including RS resource information. The present disclosure is not limited to the LTE system or NR system, and may include information for identifying RS to be used in a 6G system under current discussion. Therefore, in the present disclosure, RS information may include, for example, at least one of an RS identifier or resource information for RS.

The TCI information (e.g. TCI state information) may indicate a quasi-colocation (QCL) relationship between a target RS transmitted through a specific one antenna port and a source RS transmitted through another one antenna port. That two antenna ports are in a QCL relationship may mean that channel characteristics of symbols transmitted through one antenna port can be inferred from a channel of symbols transmitted through another antenna port. In other words, the TCI information may indicate beam channel characteristics.

The beam group index may be an index for distinguishing each of beam groups when a plurality of beam groups are configured.

The beam group-RNTI may be an identifier for monitoring a beam group control information (BeamDtxGroupControl) message transmitted to UE(s) through each of beam groups when a plurality of beam groups are configured. The beam group control information message is described in more detail below. The CBG-RNTI may be used to indicate all of the plurality of beam groups or some of the beam groups.

According to an exemplary embodiment of the present disclosure, the beam DTX time domain information (BeamDtx TimeInfo) may include one or more of the following information.
(B1) A transmission active period (TAP) in which DL wireless signals are transmitted when beam DTX is activated,
(B2) A transmission non-active period (TNP) in which transmission of DL wireless signals is stopped,
(B3) A beam DTX cycle (BDC) in which TAP and TNP are repeated, and
(B4) A beam DTX service period (BDSP) in which BDC is repeated

The DL wireless signals may include at least one of PDCCH, PDSCH, RS, and synchronization signal (SS).

In step S412, each of the UEs 311 to 315 may receive the beam DTX group configuration information (BeamDtxGroupConfig) through the corresponding DL beams 321 to 325. Each of the UEs 311 to 315 receiving the beam DTX group configuration information may identify its beam communicating with the base station, and may identify a beam group to which its beam communicating with the base station belongs. This is described in more detail as follows.

The UE #1 311 may confirm, based on the beam DTX group configuration information received through the beam #1 321, that the beam #1 321 communicating with the base station belongs to the beam group #1 331 and the beam group #4 334. The UE #2 312 may confirm, based on the beam DTX group configuration information received through the beam #2 322, that the beam #2 322 communicating with the base station belongs to the beam group #2 332. The UE #3 313 may confirm, based on the beam DTX group configuration information received through the beam #3 323, that the beam #3 323 communicating with the base station belongs to the beam group #2 332. The UE #4 314 may confirm, based on the beam DTX group configuration information received through the beam #4 324, that the beam #4 324 communicating with the base station belongs to the beam group #2 332, and that the beam #5 325 belongs to the beam group #3 333. The UE #5 315 may confirm, based on the beam DTX group configuration information received through the beam #5 325, that the beam #5 325 communicating with the base station belongs to the beam group #3 333.

As described above, each of the UEs 311 to 315 may confirm which beam group its beam communicating with the base station belongs to, and may acquire beam DTX time domain information (BeamDtxTimeInfo) related to active and non-active durations of beam DTX for communicating with the base station.

In step S421, the UE #1 311 may monitor reception of a beam group control information (BeamDtxGroupControl) message for the beam group #4 334 through the beam #1 321. In addition, in step S424, the UE #1 311 may monitor reception of a beam group control information (BeamDtxGroupControl) message for the beam group #1 331 through the beam #1 321. The reason why the UE #1 311 monitors reception of beam group control information messages for two beam groups is that the beam #1 321 for communication of the UE #1 311 belongs simultaneously to the beam group #1 331 and the beam group #4 334.

In step S422, each of the UE #2 312, the UE #3 313, and the UE #4 314 may monitor reception of a beam group control information (BeamDtxGroupControl) message for the beam group #2 332 through the beam #2 322, the beam #3 323, and the beam #4 324, respectively. In the example of FIG. 3 described above, the beam #5 325 is assumed to include the coverage of the beam #4 324. However, when a beam for communication of the UE #4 314 is the beam #4 324, the UE #4 314 may not monitor reception of a beam group control information (BeamDtxGroupControl) message for the beam group #3 333 through the beam #5 325.

In step S423, the UE #5 315 may monitor reception of a beam group control information (BeamDtxGroupControl) message for the beam group #3 333 through the beam #5 325.

In the example of FIG. 4A, the operations of steps S421 to S424 may be performed after each of the UEs 311 to 315 receives a beam DTX group configuration information message. In FIG. 4A, the steps S421 to S424 are not intended to indicate temporal operations in the same manner as illustrated in FIG. 4A.

For example, when the UE #1 311 receives the beam DTX group configuration information through the beam #1 321, the UE #1 311 may monitor reception of beam group control information messages for the beam group #1 331 and the beam group #4 334 through the beam #1 321. When the UE #2 312 receives the beam DTX group configuration information through the beam #2 322, the UE #2 312 may monitor reception of a beam group control information message for the beam group #2 332 through the beam #2 322. In other words, when each of the UEs receives the beam DTX group configuration information through beam(s) communicating with the base station, each of the UEs may monitor reception of beam group control information for a beam group based on the beam DTX group configuration information through corresponding beam(s). The beam DTX group control information may be indicated by DCI, which is a layer 1 (L1) signaling message, or may be indicated by a layer 2 (L2) signaling message (e.g. MAC CE signaling message) transmitted through a PDSCH indicated by DCI. Specific examples thereof are described in more detail below.

FIG. 4B is a sequence chart illustrating a procedure of activating beam DTX for specific beam group(s) and operations when beam DTX is activated in a communication system.

FIG. 4B illustrates operations subsequent to those of FIG. 4A. In other words, FIG. 4B illustrates operations after the beam DTX group configuration information described above with reference to FIG. 4A is transmitted to the UEs 311 to 315. In the following description of FIG. 4B, the operations of FIG. 4B are described based on the example of FIG. 3 and the operations of FIG. 4A.

In step S430, the base station 301 may determine beam group(s) for which beam DTX is to be activated. When determining beam group(s) to activate beam DTX, the base station 301 may determine beam group(s) to activate beam DTX in consideration of the number of UEs connected to the base station 301 and/or the number of UEs communicating through the beam group(s). When determining beam group(s) to activate beam DTX, the base station 301 may further consider information such as traffic load and/or beam transmission load. In addition, when determining beam group(s) to activate beam DTX, the base station 301 may additionally consider interference with neighbor beams. When considering interference with neighbor beams, neighbor beams in which interference occurs may be included in different groups, and beam DTX time domain information for each beam described below may be configured such that beam transmission times do not overlap with each other.

In other words, a case where beam DTX is required for one or more beam groups may correspond to a case where at least one of reduction in the number of communicating UEs, reduction in traffic load, reduction in beam transmission load, or reduction in interference with neighbor beams is satisfied. In this case, thresholds such as a reduction threshold of the number of UEs, a threshold of traffic load, or a threshold of interference reduction with neighbor beams may be configured in advance to determine whether beam DTX is required.

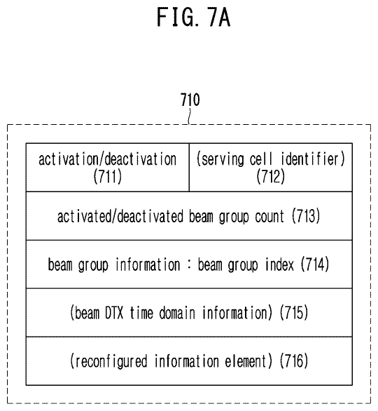

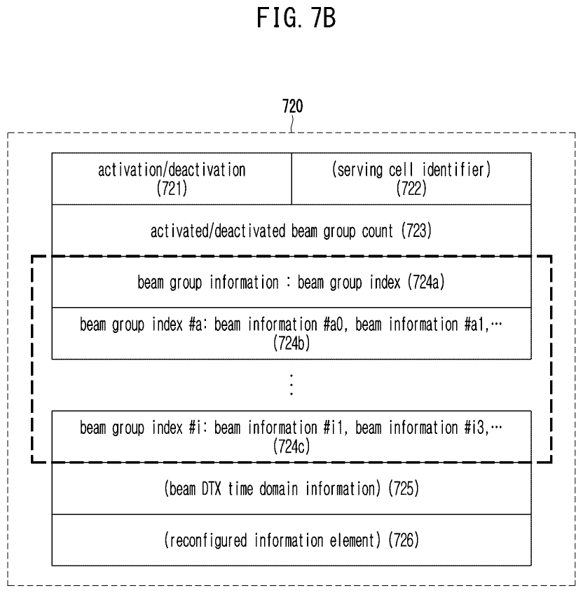

In the example of FIG. 4B, a case is assumed where it is determined to activate beam DTX for the beam group #1 331 and the beam group #2 332. Based on the determination of step S430, the base station 301 may generate a beam DTX activation indication message for the beam group #1 331, and may generate a beam DTX activation indication message for the beam group #2 332. Methods for configuring and transmitting beam DTX group control information (BeamDtxGroupControl) including beam DTX activation indication are described in more detail with reference to FIGS. 7A and 7B.

In step S432, the base station 301 may groupcast the beam DTX activation indication message for the beam group #1 331. As described above with reference to FIGS. 3 and 4A, the beam group #1 331 may include the beam #1 321 and the beam #2 322. Therefore, the base station 301 may transmit the beam DTX activation indication message for the beam group #1 331 to the UE #1 311 through the beam #1 321, and may transmit the beam DTX activation indication message for the beam group #1 331 to the UE #2 312 through the beam #2 322. The beam DTX activation indication message may refer to information indicating beam DTX activation within the beam DTX group control information.

FIG. 4B illustrates an example for describing transmission of the beam DTX activation indication message by the base station 301 through beams included in the beam group #1 331. A more detailed description on an actual procedure in which the beam DTX activation indication message is transmitted is described below.

When an omni beam is available for transmission of the beam DTX activation indication message, the beam DTX activation indication message for the group #1 331 may also be transmitted through the omni beam. In the following description, for convenience of description, it is assumed that the beam DTX activation indication message is transmitted through each of the beams 321 to 325.

In step S432, each of the UE #1 311 and the UE #2 312 may receive the beam DTX activation indication message for the beam group #1 331. Meanwhile, for the UE #1 311 and/or the UE #2 312, the beam through which the beam DTX group configuration information is received and the beam through which the beam DTX activation indication message is received may differ. For example, when the beam DTX group configuration information is transmitted through an omni beam, and the beam DTX activation indication message is transmitted through beams requiring beam DTX activation, the beam DTX group configuration information and the beam DTX activation indication message may be transmitted through different beams.

In another example, when the UE #2 312 has high mobility, the UE #2 312 may receive the beam DTX group configuration information from the beam #1 321 of the beam group #1 331, and thereafter, the UE #2 312 may move to a location of the beam #2 322 and receive the beam DTX activation indication message.

In the following description, for convenience of description, it is assumed that the UE #1 311 receives the beam DTX group configuration information and the beam DTX activation indication message through the beam #1 321 of the beam group #1 331, and the UE #2 312 receives the beam DTX group configuration information and the beam DTX activation indication message through the beam #2 322 of the beam group #1 331.

Each of the UE #1 311 and the UE #2 312 may confirm, based on the beam DTX activation indication message received from the base station 301, that beam DTX activation is indicated for the beam group #1 331.

In step S433, each of the UE #1 311 and the UE #2 312 may configure DTX activation for the beam group #1 based on the beam DTX group configuration information (BeamDtxGroupConfig) received in step S412. In other words, the UE #1 311 may confirm, based on the beam DTX group configuration information (BeamDtxGroupConfig), that the beam #1 321 is activated for DTX, and may confirm at least one of TAP, TNP, BDC, or BDSP based on the beam DTX time domain information (BeamDtxTimeInfo) of the beam #1 321. The UE #2 312 may also confirm, based on the beam DTX group configuration information (BeamDtxGroupConfig), that the beam #2 322 is activated for DTX, and may confirm at least one of TAP, TNP, BDC, or BDSP based on the beam DTX time domain information (BeamDtx TimeInfo) of the beam #2 322.

In step S434, the base station 301 may groupcast a beam DTX activation indication message for the beam group #2 332. As described above with reference to FIGS. 3 and 4A, the beam group #2 332 may include the beam #2 322, the beam #3 323, and the beam #4 324. Therefore, the base station 301 may transmit the beam DTX activation indication message for the beam group #2 332 to the UE #2 312 through the beam #2 322, may transmit the beam DTX activation indication message for the beam group #2 332 to the UE #3 313 through the beam #3 323, and may transmit the beam DTX activation indication message for the beam group #2 332 to the UE #4 314 through the beam #4 324.

In step S434, the UE #2 312, the UE #3 313, and the UE #4 314 may receive the beam DTX activation indication message for the beam group #2 332 through the beams 322, 323, and 324 communicating with the base station, respectively. Each of the UE #2 312, the UE #3 313, and the UE #4 314 may confirm, from the received beam DTX activation indication message, that beam DTX activation is indicated for the beam group #2 332.

In step S435, each of the UE #2 312, the UE #3 313, and the UE #4 314 may configure DTX activation for the beam group #2 based on the beam DTX group configuration information (BeamDtxGroupConfig) received in step S412. In other words, the UE #2 312 may confirm, based on the beam DTX group configuration information (BeamDtxGroupConfig), that the beam #2 322 is activated for DTX, and may confirm TAP, TNP, BDC, and BDSP based on the beam DTX time domain information (BeamDtxTimeInfo) of the beam #2 322. The UE #3 313 may also confirm, based on the beam DTX group configuration information (BeamDtxGroupConfig), that the beam #3 323 is activated for DTX, and may confirm at least one of TAP, TNP, BDC, or BDSP based on the beam DTX time domain information (BeamDtx Time Info) of the beam #3 323. The UE #4 314 may confirm, based on the beam DTX group configuration information (BeamDtxGroupConfig), that the beam #4 324 is activated for DTX, and may confirm at least one of TAP, TNP, BDC, or BDSP based on the beam DTX time domain information (BeamDtx TimeInfo) of the beam #4 324.

Although steps S432 and S434 are exemplified in FIG. 4B as being transmitted sequentially, the beams 321 to 325 may be transmitted simultaneously. Therefore, the beam DTX activation indication message for the beam group #1 and the beam DTX activation indication message for the beam group #2 may be transmitted simultaneously.

When the beam DTX activation indication messages are transmitted sequentially, as in FIG. 4B, the beam DTX activation indication message for the beam group #1 may be transmitted first, and the beam DTX activation indication message for the beam group #2 may be transmitted later. In another example, the beam DTX activation indication message for the beam group #2 may be transmitted first, and the beam DTX activation indication message for the beam group #1 may be transmitted later.

In step S440, the UE #1 311 and the UE #2 312 communicating through the beams 321 and 322 included in the beam group #1 331 may perform reception of DL wireless signals based on the beam DTX group configuration information (BeamDtxGroupConfig) for the beam group #1.

For example, the UE #1 311 and the UE #2 312 may confirm whether DL wireless signals are transmitted or are not transmitted through the beam #1 321 based on the beam DTX time domain information (BeamDtxTimeInfo) of the beam DTX group configuration information. Therefore, each of the UE #1 311 and the UE #2 312 may attempt to receive DL wireless signals (or message or information) through the beam #1 321 and the beam #2 322 based on the beam DTX time domain information.

In step S442, each of the UE #2 312, the UE #3 313, and the UE #4 314 communicating through the beams 322 to 324 included in the beam group #2 332 may attempt to receive DL wireless signals (or message or information) based on the beam DTX time domain information included in the beam DTX group configuration information (BeamDtxGroupConfig) for the beam group #2.

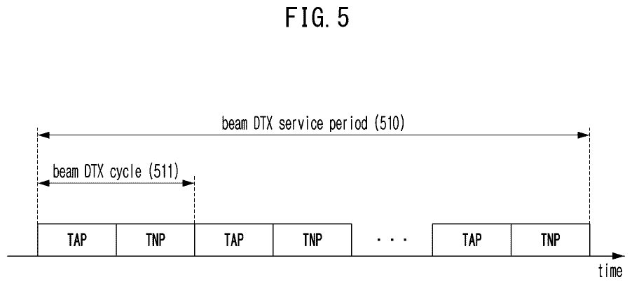

A method in which wireless signals are transmitted to a UE through DL based on the beam DTX time domain information (BeamDtxTimeInfo) of the beam DTX group configuration information is described with reference to FIG. 5.

FIG. 5 is a conceptual diagram illustrating transmission of DL wireless signals based on DTX time domain information within beam DTX group configuration information.

As described above, a UE may acquire, from DTX time domain information (BeamDtxTimeInfo) within beam DTX group configuration information, a transmission active period (TAP) in which DL wireless signals are transmitted when beam DTX is activated, a transmission non-active period (TNP) in which transmission of DL wireless signals is stopped, a beam DTX cycle (BDC) in which TAP and TNP are repeated, and a beam DTX service period (BDSP) in which BDC is repeated.

The base station 301 may transmit DL wireless signals through beam(s) included in the corresponding beam group during a TAP time duration based on the DTX time domain information (BeamDtxTimeInfo). Therefore, UE(s) that receive the DTX time domain information may monitor DL wireless signals through the corresponding beam(s) during the TAP time duration. The base station 301 may stop transmission of DL wireless signals during a TNP time duration based on the DTX time domain information. Therefore, UE(s) that receive the DTX time domain information may stop monitoring of DL wireless signals during the TNP time duration.

As illustrated in FIG. 5, a BDC 511 may be a time duration in which TAP and TNP are repeated, and the BDC 511 may continue during a BDSP 510. In other words, the base station may, based on the DTX time domain information, transmit beam(s) in the TAP time duration and stop transmission of the beam(s) in the TNP duration during the BDSP 510. Therefore, UE(s) that receive the DTX time domain information may repeatedly perform TAP and TNP for each BDC 511 during the BDSP 510. In other words, the base station 301 may perform DTX for DL wireless signals. Therefore, a UE may monitor (or attempt to receive) DL wireless signals or may stop monitoring (or stop attempting to receive) DL wireless signals in accordance with the base station 301 performing DTX for DL wireless signals.

The beam DTX time domain information (BeamDtxTimeInfo) may be provided in various types of beam DTX configuration information (BeamDtxGroupConfig). This is described in more detail with reference to FIGS. 6 to 9 described later.

Referring again to FIG. 4B, the UE #1 311 and the UE #2 312 may monitor DL wireless signals during the TAP duration through the respective beams 321 to 322 included in the beam group #1 331 as described with reference to FIG. 5, and may stop monitoring DL wireless signals during the TNP duration. In other words, the base station 301 may transmit DL wireless signals to corresponding UEs through the beams 321 and 322 included in the beam group #1 331 during the TAP duration, and may stop transmission of DL wireless signals through the beams 321 and 322 included in the beam group #1 331 during the TNP duration.

In addition, in step S442, the UE #2 312, the UE #3 313, and the UE #4 314 may monitor DL wireless signals during the TAP duration through the respective beams 322 to 324 included in the beam group #2 332 as described with reference to FIG. 5, and may stop monitoring DL wireless signals during the TNP duration. In other words, the base station 301 may transmit DL wireless signals to corresponding UEs through the beams 322 to 324 included in the beam group #2 332 during the TAP duration, and may stop transmission of DL wireless signals through the beams 322 to 324 included in the beam group #2 332 during the TNP duration.

FIG. 4C is a sequence chart illustrating a procedure of deactivating beam DTX for beam group(s) in a communication system.

FIG. 4C illustrates operations subsequent to those of FIG. 4B. In other words, FIG. 4C illustrates operations for a case where beam DTX deactivation is performed in a beam DTX activated state as described above with reference to FIG. 4B. Therefore, in the following description of FIG. 4C, the operations of FIG. 4C are described based on the example of FIG. 3 and the operations of FIGS. 4A and 4B.

In step S450, the base station 301 may determine deactivation of beam DTX for the beam group #2 332. Determination of beam DTX deactivation for a beam group in a beam DTX activated state may be made by various factors. For example, when the number of UEs increases or when an amount of data to be transmitted increases in a beam group in the beam DTX activated state, beam DTX deactivation may be determined for the beam group. In another example, when a BDSP in which BDC is repeated for a beam group in the beam DTX activated state expires, the base station 301 may determine beam DTX deactivation for the beam group. The base station 301 may generate a beam DTX deactivation indication message of the beam group #2 332 based on the determination of beam DTX deactivation for the beam group #2 332. In this case, thresholds for determining a case where beam DTX is to be deactivated may be configured in advance.

In step S452, the base station 301 may transmit the beam DTX deactivation indication message for the beam group #2 332 to the UE #2 312, the UE #3 313, and the UE #4 314 through the beams 322 to 324 included in the beam group #2 332. In this case, the beam DTX deactivation indication message may be transmitted during the TAP duration. In other words, since the beam group #2 332 is currently in the beam DTX activated state as described above with reference to FIG. 4B, the base station 301 may transmit the beam DTX deactivation indication message during the TAP duration.

As described above with reference to FIG. 4B, FIG. 4C also illustrates an example for describing that the base station 301 transmits the beam DTX deactivation indication message through beams included in the beam group #2 332. A more detailed operation of a procedure in which the beam DTX deactivation indication message is transmitted is described in the following description. The beam DTX deactivation indication message may refer to information indicating beam DTX deactivation within the beam DTX group control information.

In step S452, the UE #2 312, the UE #3 313, and the UE #4 314 may receive the beam DTX deactivation indication message for the beam group #2 332 by monitoring the TAP duration of the beams 322 to 324 communicating with the base station 301.

In step S454, the UE #2 312, the UE #3 313, and the UE #4 314 may configure beams of the beam group #2 332 to a beam DTX deactivated state in response to reception of the beam DTX deactivation indication message for the beam group #2 332. In other words, the UE #2 312, UE #3 313, and UE #4 314 may continuously monitor beams included in the beam group #2 332.

In step S460, the base station 301 may determine beam DTX deactivation for the beam group #1 331. Step S460 may be the same procedure as step S450 described earlier. However, step S450 is a step of determining beam DTX deactivation for the beam group #2 332, and step S460 is a step of determining beam DTX deactivation for the beam group #1 331.

In step S462, the base station 301 may transmit a beam DTX deactivation indication message for the beam group #1 331 to the UE #1 311 and the UE #2 312 through the beams 321 and 322 included in the beam group #1 331. Step S462 may also be the same procedure as step S452 described earlier.

In step S464, the UE #1 311 and the UE #2 312 may configure beams of the beam group #1 331 to a beam DTX deactivated state in response to reception of the beam DTX deactivation indication message for the beam group #1 331.

FIGS. 4A to 4C described above have described the procedure in which the base station 301 transmits beam DTX group configuration information (BeamDtxGroupConfig) to the UEs 311 to 315 in a case where the base station 301 has a plurality of beam groups, and beams belonging to specific beam group(s) are beam DTX activated and transmitted in response to beam DTX activation indication for the corresponding beam group(s). In addition, the procedure of communicating through beams of beam groups in the beam DTX activated state and beam DTX deactivation for beam groups in the beam DTX activated state have been described.

Hereinafter, configuration and types of messages transmitted in the procedure of FIGS. 4A to 4C are described.

FIG. 6A is a conceptual diagram illustrating a configuration of a first type of beam DTX configuration information.

Referring to FIG. 6A, a configuration of a first type of beam DTX group configuration information 600a is illustrated. The first type of beam DTX group configuration information 600a may include a common beam group-RNTI (CBG-RNTI) 601. The CBG-RNTI 601 may indicate an RNTI commonly used in beam groups as described above with reference to FIG. 4A.

The first type of beam DTX group configuration information 600a may include beam group information #1 610, beam group information #2 620, . . . , and beam group information #n 630. The beam group information #1 610 may mean information on the beam group #1, the beam group information #2 620 may mean information on the beam group #2, and the beam group information #n 630 may mean information on the beam group #n.

The beam group information #1 610 may include a beam group index #1 611, beam information 612 on beams included in the beam group #1, and a beam group-RNTI 613 corresponding to the beam group #1. The beam group index #1 611 may be an index for distinguishing the beam group #1. The beam information 612 on beams included in the beam group #1 may be information on respective beams included in the beam group #1. More specifically, beam information #10 may include at least one of a beam index, RS information, or TCI corresponding to a beam #10, beam information #11 may include at least one of a beam index, RS information, or TCI corresponding to a beam #11, and beam information #li may include at least one of a beam index, RS information, or TCI corresponding to a beam #li.

A beam group-RNTI (BG-RNTI) may be an identifier for controlling a specific beam group for UE(s) communicating through beams included in the specific beam group. For example, the BG-RNTI may be an identifier for identifying beam DTX group control information (BeamDtxGroupControl) such as the beam DTX activation indication message for the beam group #1 described above in FIG. 4B and/or the beam DTX deactivation indication message for the beam group #1 described above in FIG. 4C. A usage example of BG-RNTI may be as follows.

For example, in order to notify UEs of transmission of the beam DTX activation indication message for the beam group #1, the base station 301 may configure DCI. In this case, the base station 301 may scramble the DCI using the BG-RNTI and transmit the DCI to UE(s). After transmitting the DCI to UE(s) through a PDCCH, the base station may transmit the beam DTX activation indication message to the UE(s) through a PDSCH based on the DCI.

The DCI transmitted by the base station to the UEs through the PDCCH may include DL or UL scheduling information. The DCI may be an L1 signaling message. The DCI transmitted by the base station may be scrambled by an RNTI for a specific purpose and transmitted to UEs. Therefore, a UE monitoring the DCI for a specific purpose may confirm whether the DCI is received through a PDCCH by using the RNTI corresponding to the purpose. In other words, when the UE succeeds in decoding the DCI received through the PDCCH using the RNTI for the specific purpose, the UE may determine that the DCI based on the purpose of the RNTI is received. Therefore, the UE that succeeds in decoding the DCI may perform an additional operation based on what the DCI indicates.

For example, when the DCI includes activation/deactivation indication information of beam DTX operations described in the present disclosure, activation/deactivation of beam DTX operations may be configured based on the indication of the DCI.

For another example, when the DCI indicates reception of a PDSCH including activation/deactivation indication information of beam DTX operations described in the present disclosure, an L2 signaling message (e.g. MAC CE message) may be received through a PDSCH indicated by the DCI.

UE(s) communicating with the base station 301 through beams included in the beam group #1 may receive the DCI transmitted through the PDCCH and de-scramble the received DCI using the BG-RNTI. When the DCI is acquired by de-scrambling the DCI using the BG-RNTI, the UE(s) may receive a beam DTX activation indication message through the PDSCH indicated by the DCI. For another example, when the DCI is acquired by de-scrambling the DCI using the BG-RNTI, the UEs may identify a beam DTX activation indication included in the DCI.

In the above description, transmission and reception of the beam DTX activation indication message has been described, but the same procedure may be performed in a case where a beam DTX deactivation indication message is transmitted and/or received.

Meanwhile, the base station 301 may perform beam DTX activation indication/beam DTX deactivation indication for each beam group as described above, or the base station 301 may perform beam DTX activation indication/beam DTX deactivation indication for all beams belonging to the base station.

When the base station 301 desires to perform beam DTX activation indication for all beam groups included in the beam DTX group configuration information 600a, the base station 301 may transmit DCI to all UEs belonging to the base station using the CBG-RNTI 601. All UEs communicating with the base station 301 within the base station 301 may de-scramble the DCI received through a PDCCH using the CBG-RNTI 601.

When the UEs acquire the DCI by de-scrambling using the CBG-RNTI 601, the UEs that acquire the DCI may receive a beam DTX activation indication message through a PDSCH indicated by the DCI. Since subsequent procedures are described above in FIG. 4B, a redundant description is omitted.

The above description describes the case where the base station 301 transmits a beam DTX activation indication using the CBG-RNTI 601, but the beam DTX deactivation indication may also be transmitted in the same manner. In other words, when the base station 301 desires to perform simultaneous control of all beams within the base station, the base station 301 may scramble beam DTX group control information (BeamDtxGroupControl) using the CBG-RNTI 601 and transmit the beam DTX group control information to all UEs communicating with the base station 301.

In addition, the beam group information #1 610 may include beam DTX time domain information #1 614. The beam DTX time domain information #1 614 may include at least one of TAP, TNP, BCD, or BDSP as described above with reference to FIG. 4A.

FIG. 6A illustrates a case of assuming that the beam DTX time domain information #1 614 is included in the beam group information #1 610, but the present disclosure should not be understood as being limited to the beam DTX time domain information #1 614 being included in the beam group information #1 610 as exemplified in FIG. 6A.

The beam DTX time domain information #1 614 may be in a form not included in the beam group information #1 610. For example, when the beam DTX time domain information #1 614 is not included in the beam group information #1 610, the beam DTX time domain information #1 614 may be configured in a form associated with the beam group information #1 610. In another example, the beam DTX time domain information #1 614 may further include association information with the beam group information #1 610. In another example, the beam group information #1 610 may further include association information with the beam DTX time domain information #1 614.

The beam group information #2 620 may include a beam group index #2 621, beam information 622 on beams included in the beam group #2, and a beam group-RNTI 623 corresponding to the beam group #2, and the beam group information #n 630 may include a beam group index #n 631, beam information 632 on beams included in the beam group #n, and a beam group-RNTI 633 corresponding to the beam group #n. Since the information included in the beam group information #2 620 and the beam group information #n 630 may have the same configuration as the beam group information #1 610, a redundant description is omitted.

FIG. 6B is a conceptual diagram illustrating a configuration of a second type of beam DTX configuration information.

Referring to FIG. 6B, a configuration of a second type of beam DTX group configuration information 600b is illustrated. The second type of beam DTX group configuration information 600b may include a CBG-RNTI 601. The CBG-RNTI 601 may indicate an RNTI commonly used in beam groups.

Similarly to the first type of beam DTX group configuration information 600a, the second type of beam DTX group configuration information 600b may include beam group information #1 610, beam group information #2 620, . . . , and beam group information #n 630. The beam group information #1 610 may mean information on the beam group #1, the beam group information #2 620 may mean information on the beam group #2, and the beam group information #n 630 may mean information on the beam group #n.

The beam group information #1 610 may include a beam group index #1 611, beam information 612 on beams included in the beam group #1, and a beam group-RNTI 613 corresponding to the beam group #1. The beam group information #2 620 may include a beam group index #2 621, beam information 622 on beams included in the beam group #2, and a beam group-RNTI 623 corresponding to the beam group #2. In addition, the beam group information #n 630 may include a beam group index #n 631, beam information 632 on beams included in the beam group #n, and a beam group-RNTI 633 corresponding to the beam group #n.

The second type of beam DTX group configuration information 600b may include beam DTX time domain information 641, . . . , and 642 not associated with the beam group information #1 610, beam group information #2 620, . . . , and beam group information #n 630. Each of the beam DTX time domain information 641, . . . , and 642 may include at least one of TAP, TNP, BCD, or BDSP as described above with reference to FIG. 4A.

As illustrated in FIG. 6B, when the beam DTX group configuration information 600b is configured so that there is no association between beam group information and beam DTX time domain information, mapping indication information for mapping between a specific beam group information and a specific beam DTX time domain information may be needed. The mapping indication information may be transmitted through the beam DTX group control information (BeamDtxGroupControl). A method of utilizing the mapping indication information is described in more detail hereinafter.

FIG. 6C is a conceptual diagram illustrating a configuration of a third type of beam DTX configuration information.

Referring to FIG. 6C, a configuration of a third type of beam DTX group configuration information 600c is illustrated. The third type of beam DTX group configuration information 600c may include a CBG-RNTI 601. The CBG-RNTI 601 may indicate an RNTI commonly used in beam groups.

The third type of beam DTX group configuration information 600c, similarly to the first type of beam DTX group configuration information 600a and the second type of beam DTX group configuration information 600b described above, may include beam group information #1 610, beam group information #2 620, . . . , and beam group information #n 630. The beam group information #1 610 may mean information on the beam group #1, the beam group information #2 620 may mean information on the beam group #2, and the beam group information #n 630 may mean information on the beam group #n.

The beam group information #1 610 may include a beam group index #1 611, beam information 612 on beams included in the beam group #1, and a beam group-RNTI 613 corresponding to the beam group #1. The beam group information #2 620 may include a beam group index #2 621, beam information 622 on beams included in the beam group #2, and a beam group-RNTI 623 corresponding to the beam group #2. In addition, the beam group information #n 630 may include a beam group index #n 631, beam information 632 on beams included in the beam group #n, and a beam group-RNTI 633 corresponding to the beam group #n.

The third type of beam DTX group configuration information 600c may include common beam DTX time domain information 651 commonly applied to all of the beam group information #1 610, beam group information #2 620, . . . , and beam group information #n 630. The common beam DTX time domain information 651 may include at least one of TAP, TNP, BCD, or BDSP as described above with reference to FIG. 4A.

FIG. 6D is a conceptual diagram illustrating a configuration of a fourth type of beam DTX configuration information and cell-common DTX configuration information.

Referring to FIG. 6D, cell-common DTX configuration information (CellCommonDtxConfig) 660 and a fourth type of beam DTX group configuration information 600d are illustrated.

The cell-common DTX configuration information 660 may include cell-common beam DTX time information 661. The cell-common beam DTX time information 661 may include at least one of TAP, TNP, BCD, or BDSP as described above with reference to FIG. 4A. TAP, TNP, BCD, and BDSP included in the cell-common beam DTX time information 661 may be beam DTX time information commonly applied to all beams within a cell.

Since the cell-common beam DTX time information 661 is transmitted through the cell-common DTX configuration information 660, the fourth type of beam DTX group configuration information 600d may include only a CBG-RNTI 601, beam group information #1 610, beam group information #2 620, . . . , and beam group information #n 630.

The CBG-RNTI 601 may indicate an RNTI commonly used in beam groups. The beam group information #1 610 may mean information on the beam group #1, the beam group information #2 620 may mean information on the beam group #2, and the beam group information #n 630 may mean information on the beam group #n.

The beam group information #1 610 may include a beam group index #1 611, beam information 612 on beams included in the beam group #1, and a beam group-RNTI 613 corresponding to the beam group #1. The beam group information #2 620 may include a beam group index #2 621, beam information 622 on beams included in the beam group #2, and a beam group-RNTI 623 corresponding to the beam group #2. In addition, the beam group information #n 630 may include a beam group index #n 631, beam information 632 on beams included in the beam group #n, and a beam group-RNTI 633 corresponding to the beam group #n.

Meanwhile, the beam DTX group configuration information of FIGS. 6A to 6D described above may be transmitted through a higher layer signaling message (e.g. RRC signaling message). In addition, when all of the beam DTX group configuration information types described in FIGS. 6A to 6D are used, the beam DTX group configuration information may further include type information for indicating its type.

FIG. 7A is a conceptual diagram illustrating a configuration of a first type of beam DTX group control information.

A first type of beam DTX group control information (BeamDtxGroupControl) 710 may include the following fields.
Activation/deactivation field 711: The activation/deactivation field 711 may be a field indicating whether beam DTX is activated or beam DTX is deactivated. The activation/deactivation field 711 may include an activation/deactivation indicator or activation/deactivation indication information.

Meanwhile, the first type of beam DTX group control information 710 may not include the activation/deactivation field 711. For example, when a predefined specific message is received, the message may be understood as indicating beam DTX activation or beam DTX deactivation. A more specific example is described by assuming the predefined specific message as ‘first DCI’. A UE may receive the first DCI through a PDCCH, and when a current state is the beam DTX deactivated state, the UE may determine that beam DTX activation is indicated. A UE may receive the first DCI through a PDCCH, and when a current state is the beam DTX activated state, the UE may determine that beam DTX deactivation is indicated. In the exemplary embodiment described above, the first DCI, which is an L1 signaling message, is described as an example, but another control message, for example, an L2 signaling message, may also be used.

Additionally, when a beam DTX activation/deactivation indication is transmitted based on reception of DCI or a control message, a UE may further perform an operation of reporting a completion report for beam DTX activation/deactivation to a base station. This reporting operation may be a procedure for synchronizing a beam DTX activated or deactivated state between the base station and the UE or for correcting an error of the beam DTX activated or deactivated state.
Serving cell ID field 712: The serving cell ID field 712 may be a field in which identifier information of a serving cell is included.
Activated/deactivated beam group count field 713: The activated/deactivated beam group count field 713 may be a field in which information on a number of beam groups to be activated/deactivated is included. The number of beam groups to be activated/deactivated may be expressed in binary bits. For example, when the activated/deactivated beam group count field is configured with 3 bits and the number of beam groups to be activated is three, the activated/deactivated beam group count field 713 may have a value of ‘011’. In another example, when the activated/deactivated beam group count field 713 is configured with 3 bits and the number of beam groups to be deactivated is four, the activated/deactivated beam group count field 713 may have a value of ‘100’. Here, a number of bits constituting the activated/deactivated beam group count field 713 is merely one example for facilitating understanding, and the present disclosure should not be understood as being limited thereto.
Beam group information field 714: The beam group information field 714 may be a field indicating information on beams included in a corresponding beam group by using a beam group index included in beam DTX configuration information transmitted in the types such as FIGS. 6A to 6D. The beam group information field 714 may include one or two or more beam group indexes.
Beam DTX time domain information field 715: The beam DTX time domain information field 715 may be a mapping indication information field for mapping between beam group information and beam DTX time domain information in a case where the second type of beam DTX group configuration information 600b described in FIG. 6B is transmitted to the UE. The beam DTX time domain information field 715 may include an indicator of beam DTX time domain information to be activated.

When the activated/deactivated beam group count field 713 is set to 1, the beam group information field 714 may indicate only one beam group index. When only one beam group index is included in the first type of beam DTX group control information 700, the beam DTX time domain information field 715 may include only one indicator of beam DTX time domain information for indicating one beam DTX time domain information. In addition, one beam group index included in the first type of beam DTX group control information 710 may configure at least one of TAP, TNP, BCD, or BDSP according to the beam DTX time domain information corresponding to the indicator of one beam DTX time domain information included in the first type of beam DTX group control information 710.

When the activated/deactivated beam group count field 713 is set to 2 or more, and two or more beam group indexes are included in the beam group information field 714, a mapping relationship between beam indexes and beam DTX time domain information may be explicitly or implicitly configured in the beam DTX time domain information field 715. When the mapping relationship between beam indexes and beam DTX time domain information is implicitly configured, an order of the beam indexes in the beam group information field 714 may correspond to an order of indicators of the beam DTX time domain information included in the beam DTX time domain information field 715.

Although the activated/deactivated beam group count field 713 is set to 2 or more, and two or more beam group indexes are included in the beam group information field 714, only one indicator of beam DTX time domain information is included in the beam DTX time domain information field 715, all beam groups included in the beam group information field 714 may be configured with beam DTX time domain information corresponding to the indicators of the beam DTX time domain information included in the beam DTX time domain information field 715.
Reconfigured information element field 716: When reconfiguration is required for one or more information elements (IEs) among IEs included in the beam group information and the beam DTX time domain information provided to the UE through the beam DTX group configuration information, the one or more IEs to be reconfigured may be included in this field. When there is no IE to be reconfigured, the reconfigured information element field 716 may be omitted or may be filled with a dummy.

The fields exemplified in FIG. 7A described above are for facilitating understanding of the present disclosure, and not all fields exemplified in FIG. 7A may be transmitted. For example, the beam DTX group control information may include only the beam DTX activation/deactivation indication field. In another example, as described above, the beam DTX group control information may be implicitly indicated without the beam DTX activation/deactivation indication field. When beam DTX activation/deactivation is implicitly indicated by DCI, a beam group may be indicated by an RNTI for scrambling the DCI.

FIG. 7B is a conceptual diagram illustrating a configuration of a second type of beam DTX group control information.

A second type of beam DTX group control information (BeamDtxGroupControl) 720 may be a modified form of the first type of beam DTX group control information described in FIG. 7A. When the second type of beam DTX group control information is compared with the first type of beam DTX group control information described in FIG. 7A, the following fields may be identical.

An activation/deactivation field 721 exemplified in FIG. 7B may be the same field as the activation/deactivation field 711 described in FIG. 7A, a serving cell ID field 722 exemplified in FIG. 7B may be the same field as the serving cell ID field 712 described in FIG. 7A, and an activated/deactivated beam group count field 723 exemplified in FIG. 7B may be the same field as the activated/deactivated beam group count field 713 described in FIG. 7A.

In addition, a beam DTX time domain information field 725 exemplified in FIG. 7B may be the same field as the beam DTX time domain information field 715 described in FIG. 7A, and a reconfigured information element field 726 exemplified in FIG. 7B may also be the same field as the reconfigured information element field 716 described in FIG. 7A.

The first type of beam DTX group control information 710 exemplified in FIG. 7A has a configuration including the beam group information field 714, whereas the second type of beam DTX group control information 720 exemplified in FIG. 7B may have a configuration further including beam group index fields 724b, . . . , and 724c in addition to a beam group information field 724a. Therefore, the first type of beam DTX group control information 710 exemplified in FIG. 7A may indicate only specific beam index(es) in the beam group information field 714. In contrast, the second type of beam DTX group control information 720 exemplified in FIG. 7B may indicate specific beam group index(es) in the beam group information field 724a and may further include fields 724b, . . . , and 724c for indicating beams corresponding to the respective beam group index(es). Therefore, the second type of beam DTX group control information 720 exemplified in FIG. 7B may indicate beam DTX activation/deactivation for all beams within a specific group or may indicate beam DTX activation/deactivation only for some beams within a specific group.

The second type of beam DTX group control information 720 as in FIG. 7B may be used in a case where beam DTX control is to be performed only for some beams among beams included in a specific beam group in beam DTX configuration information. For example, the beam group #2 332 of FIG. 3 may include the beam #2 322, the beam #3 323, and the beam #4 324. In this case, when the base station 301 desires to perform beam DTX control only for the beam #2 322 and the beam #4 324 among the beams of the beam group #2 332, the base station 301 may configure the second type of beam DTX group control information 720 as in FIG. 7B.

In other words, in the second type of beam DTX group control information 720, the beam group information field 724 may include a beam group index for the beam group #2 332. In addition, the second type of beam DTX group control information 720 may further include, in one field corresponding to the beam group #2 332 among the fields 724b, . . . , and 724c for indicating beams for which beam DTX control is to be performed with respect to the respective beam group indexes, information on beams (e.g. beam #2 322 and beam #4 324) for which beam DTX control is to be performed.

Meanwhile, in the above description, a case where the beams included in the fields of reference numerals 724b, . . . , and 724c are selected beams for which beam DTX control is to be performed is assumed and described. However, beams included in the fields of reference numerals 724b, . . . , and 724c may be beams that are not selected, in other words, beams to be excluded.

In the following description, for convenience of description, information on beams to perform beam DTX control within a specific beam group is referred to as ‘beam group-selected beam information’ and the fields of reference numerals 724b, . . . , and 724c are referred to as ‘beam group-selected beam information fields.

In the following description, usage examples where the beam DTX scheme is applied are described. More specifically, procedures for cases where the beam DTX scheme is activated/deactivated by using beam DTX group configuration information according to one of the methods among FIGS. 6A to 6D and beam DTX group control information according to one of the methods among FIGS. 7A and 7B are described below. In addition, cases where the beam DTX scheme is activated/deactivated are described based on the sequence charts of FIGS. 4A to 4C described above, and beam groups are described based on contents described in FIG. 3.

The beam DTX group control information according to FIGS. 7A and 7B described above may be transmitted through a MAC CE message. In addition, when the beam DTX group control information types described in FIGS. 7A and 7B are all used, the beam DTX group control information may further include type information for indicating its type.

### Usage Example #1 of a Combination of Beam DTX Group Configuration Information and Beam DTX Group Control Information

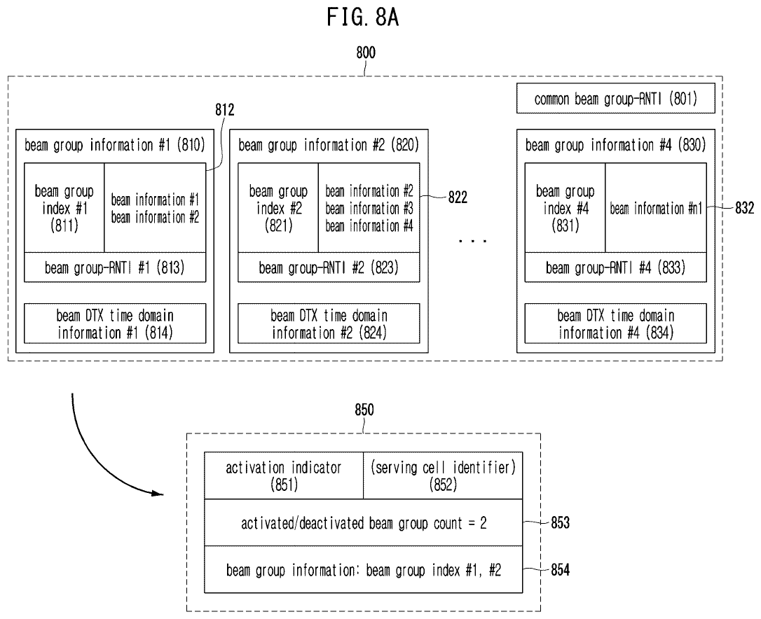

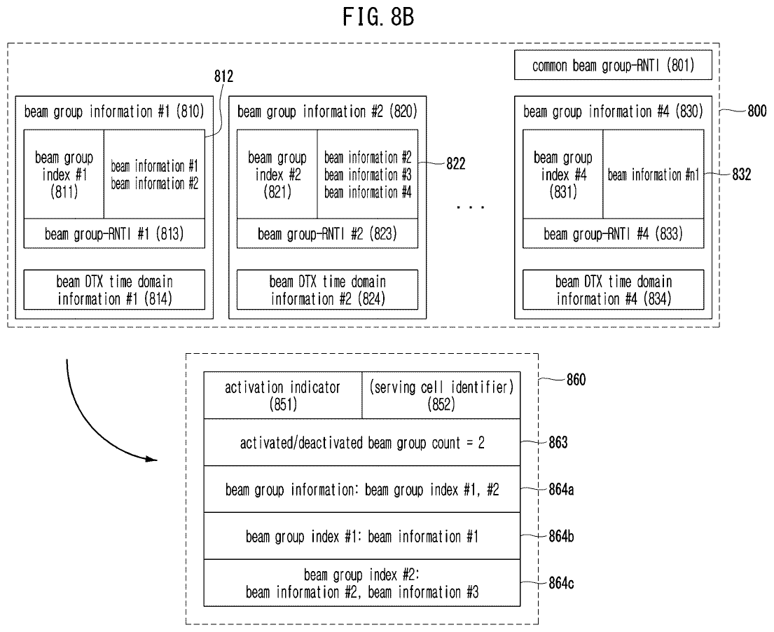

FIG. 8A is a conceptual diagram illustrating a first exemplary embodiment of an activation procedure of a specific beam group using beam DTX group configuration information and beam DTX group control information.

In step S410, the base station 301 may generate beam DTX group configuration information (BeamDtxGroupConfig) 800. The beam DTX group configuration information 800 illustrated in FIG. 8A may be the first type of beam DTX group configuration information described in FIG. 6A.

When the base station 301 has four beam groups 331 to 334 as illustrated in FIG. 3, the beam DTX group configuration information 800 may include a CBG-RNTI 801 and beam group information 810, 820, . . . , and 830 respectively corresponding to the four beam groups. In FIG. 8A, only the beam group information 810, 820, and 830 for three of the four beam groups is illustrated, and it should be noted that the beam group information for the beam group #3 333 is omitted.

The beam group information #1 810 may include information on the beam group #1 331 illustrated in FIG. 3. For example, the beam group information #1 810 may include a beam group index #1 811 and beam information 812 on the beam group #1 331. More specifically, the beam information 812 on the beam group #1 331 may include beam information #1 on the beam #1 321 included in the beam group #1 331, and beam information #2 on the beam #2 322 included in the beam group #1 331. The beam information #1 and beam information #2 may each include at least one of a beam index, RS information, or TCI for the corresponding beam. In the case of the beam information #1, the beam index may be beam index #1, and in the case of the beam information #2, the beam index may be beam index #2.

The beam group information #1 810 may include a beam group-RNTI #1 813. The beam group-RNTI #1 813 may be an identifier for transmitting control information (or signal or message) of the beam group #1 331 to UE(s) that receive DL wireless signals through beams included in the beam group #1 331.

The beam group control information #1 810 may include beam DTX time domain information #1 814 as described in FIG. 6A. In another example, the beam group control information #1 810 and the beam DTX time domain information #1 814 may be configured in an associated form.

The beam group information #2 820 may include information on the beam group #2 332 illustrated in FIG. 3. For example, the beam group information #2 820 may include a beam group index #2 821, beam information #2 on the beam #2 322 included in the beam group #2 332, beam information #3 on the beam #3 323 included in the beam group #2 332, and beam information #4 on the beam #4 324 included in the beam group #2 332. The beam information #2, beam information #3, and beam information #4 may also each include at least one of a beam index, RS information, or TCI for the corresponding beam. In the case of the beam information #2, the beam index may be beam index #2, in the case of the beam information #3, the beam index may be beam index #3, and in the case of the beam information #4, the beam index may be beam index #4.

The beam group information #2 820 may include a beam group-RNTI #2 823. The beam group-RNTI #2 823 may be an identifier for transmitting control information (or signal or message) of the beam group #2 332 to UE(s) that receive DL wireless signals through beams included in the beam group #2 332.

The beam group control information #2 820 may include beam DTX time domain information #2 814 as described in FIG. 6A. In another example, the beam group control information #2 820 and the beam DTX time domain information #2 824 may be configured in an associated form.

The beam group information #4 830 may include information on the beam group #4 334 illustrated in FIG. 3. As illustrated in FIG. 3, the beam group #4 334 may be a beam group consisting of a single beam, and information in a form similar to that described in the beam group information #1 810 and the beam group information #2 820 may be included in the beam group information #4 830.

In step S412, base station 301 may transmit (broadcast, multicast, or unicast) the beam DTX group configuration information 800 to UEs. Therefore, the UEs 311 to 315 belonging to the base station 301 may receive the beam DTX group configuration information 800 in step S412.

In steps S421 to S424, the UE #1 311, UE #2 312, UE #3 313, UE #4 314, and UE #5 315 may monitor control messages through beams received from base station 301. For example, each of the UEs 311 to 315 may monitor reception of beam DTX group control information by using the beam group-RNTI included in beam group information through the beam with which each UE communicates. In addition, each of the UEs 311 to 315 may monitor reception of beam DTX group control information by using the CBG-RNTI 801. The monitoring operation of the UEs may refer to an operation of acquiring DCI by de-scrambling a signal received through a PDCCH using a specific RNTI (e.g. the beam group-RNTI included in beam group information or the CBG-RNTI) as described above.

In the following description, it is assumed that each of UEs 311 to 315 monitors reception of beam DTX group control information by using the CBG-RNTI 801.

In step S430, the base station 301 may determine a beam group for which beam DTX is to be activated. FIG. 8A corresponds to a case where beam DTX activation is indicated for beams of the beam group #1 and the beam group #2. The base station 301 may generate beam DTX group control information (BeamDtxGroupControl) 850 indicating beam DTX activation of the beam group #1 and the beam group #2. The beam DTX group control information illustrated in FIG. 8A may be the first type of beam DTX group control information described in FIG. 7A, and may be in a form excluding the beam DTX time domain information field and the reconfigured information element field described in FIG. 7A.

In configuring the first type of beam DTX group control information 850, the base station 301 may set the activation/deactivation field 851 to an activation indication. In addition, when at least one UE communicating in the corresponding beam group has a plurality of serving cells, the base station 301 may set a serving cell identifier in the serving cell identifier field 852. In another example, the base station 301 may unconditionally set a serving cell identifier in the serving cell identifier field 852.

The base station 301 may indicate that two groups are to be activated by setting 2 in the activated/deactivated beam group count field of the beam DTX group control information 850. In addition, the base station 301 may set beam group indexes (i.e. beam group index #1 and beam group index #2) in the beam group information field of the beam DTX group control information 850.

In steps S432 and S434, the base station 301 may transmit DCI having a CRC scrambled with the CBG-RNTI 801 through all beams or beams for which beam DTX activation is to be indicated. The DCI transmitted by the base station 301 may indicate reception of a PDSCH on which the first type of beam DTX group control information 850 is transmitted. The base station 301 may transmit the first type of beam DTX group control information 850 to UEs through a resource indicated by the DCI.

Each of the UEs 311 to 315 may monitor a PDCCH and may de-scramble a signal received from the PDCCH with the CBG-RNTI 801. If the DCI is acquired as a result of de-scrambling using the CBG-RNTI 801, the UE(s) acquiring the DCI may receive the first type of beam DTX group control information 850 through a PDSCH indicated by the DCI.

In steps S433 and S435, the UE(s) that receive the first type of beam DTX group control information 850 may determine whether beam DTX activation of a beam group to which its beam communicating with the base station 301 belongs is indicated. If beam DTX activation is indicated for the beam group to which its beam communicating with the base station 301 belongs, the UE(s) may be configured to perform reception operations according to beam DTX based on beam DTX time domain information included in the beam DTX configuration information.

In step S440, the UE #1 311 and the UE #2 312, which receive DL wireless signals from the base station 301 through the beams 321 and 322 included in the beam group #1 331, may receive DL wireless signals from the base station 301 based on TAP, TNP, BCD, and BDSP included in the beam DTX time domain information #1 814. In other words, the base station 301 may perform DTX of the DL wireless signals. Therefore, the UE may monitor (or attempt to receive) DL wireless signals in accordance with the base station 301 performing DTX of the DL wireless signals, or may stop monitoring (or stop attempting to receive) the DL wireless signals.

In step S442, the UE #2 312, the UE #3 313, and the UE #4 314, which receive DL wireless signals from the base station 301 through the beams 322, 323, and 324 included in the beam group #2 332, may receive DL wireless signals from the base station 301 based on TAP, TNP, BCD, and BDSP included in the beam DTX time domain information #2 824.

The procedure and method in which the UE receives DL wireless signals from the base station 301 based on TAP, TNP, BCD, and BDSP have already been described with reference to FIG. 5, and thus a redundant description is omitted.

Each of TAP, TNP, BCD, and BDSP included in the beam DTX time domain information #1 814 may be different from each of TAP, TNP, BCD, and BDSP included in the beam DTX time domain information #2 824. When each of TAP, TNP, BCD, and BDSP included in the beam DTX time domain information #1 814 is different from each of TAP, TNP, BCD, and BDSP included in the beam DTX time domain information #2 824, the base station 301 may separately indicate beam DTX time domain information to be used for the UE #2 312 belonging to both the beam group #1 331 and the beam group #2 332.

For example, the base station 301 may instruct the UE #2 312 belonging to both the beam group #1 331 and the beam group #2 332 to perform beam DTX based on the beam DTX time domain information #1 814. In this case, the base station 301 may perform transmission of the beam #2 312 or stop transmission of the beam #2 312 based on the beam DTX time domain information #1 814.

In another example, the base station 301 may instruct the UE #2 312 belonging to both the beam group #1 331 and the beam group #2 332 to perform beam DTX based on the beam DTX time domain information #2 824. In this case, the base station 301 may perform transmission of the beam #2 312 or stop transmission of the beam #2 312 based on the beam DTX time domain information #2 824.

A beam deactivation indication may be a procedure in which the activation/deactivation indication field 851 of the beam DTX group control information 850 illustrated in FIG. 8A is transmitted with its value set to a deactivation indication. Since other fields and operations thereof may be understood as in the procedures according to the activation indication, a description on the procedures according to the deactivation indication is omitted.

### Usage Example #2 of a Combination of Beam DTX Group Configuration Information and Beam DTX Group Control Information

FIG. 8B is a conceptual diagram illustrating a second exemplary embodiment of an activation procedure of a specific beam group by using beam DTX group configuration information and beam DTX group control information.

In step S410, the base station 301 may generate beam DTX group configuration information 800, and in step S412, the base station 301 may transmit (broadcast, multicast, or unicast) the generated beam DTX group configuration information 800 to UEs through all beams. Therefore, the UEs 311 to 315 belonging to the base station 301 may receive the beam DTX group configuration information 800 in step S412.

The beam DTX group configuration information 800 in FIG. 8B may have the same configuration as described in FIG. 8A. Therefore, it should be noted that in FIG. 8B, the specific configuration of the beam DTX group configuration information 800 is omitted for simplicity. In other words, the beam DTX group configuration information 800 may be the first type of beam DTX group configuration information described in FIG. 6A. Therefore, the description on the beam DTX group configuration information 800 having the same configuration as in FIG. 8A is omitted.

In steps S421 to S424, the UE #1 311, UE #2 312, UE #3 313, UE #4 314, and UE #5 315 may monitor control messages through beams received from the base station 301. As described in FIG. 8A, it is assumed that each of the UEs 311 to 315 monitors reception of the beam DTX group control information by using the CBG-RNTI 801.

In step S430, the base station 301 may determine a beam group for which beam DTX is to be activated. FIG. 8B may correspond to a case where beam DTX activation is indicated for beams of the beam group #1 and the beam group #2 as described with reference to FIG. 8A. The base station 301 may generate beam DTX group control information (BeamDtxGroupControl) 860 indicating activation of the beam group #1 and the beam group #2. The beam DTX group control information illustrated in FIG. 8B may be the second type of beam DTX group control information described in FIG. 7B and may be in a form excluding the beam DTX time domain information field and the reconfigured information element field described in FIG. 7B.

In configuring the second type of beam DTX group control information 860, the base station 301 may set an activation/deactivation field 861 to an activation indication, and when one or more UEs communicating in the corresponding beam group have a plurality of serving cells, the base station 301 may set a serving cell identifier in a serving cell identifier field 862. In another example, the base station 301 may unconditionally set a serving cell identifier in the serving cell identifier field 862. When a serving cell identifier is not included in the serving cell identifier field 862, the field may be padded with zero bits.

By setting a value of 2 in an activated/deactivated beam group count field 863 in the second type of beam DTX group control information 860, the base station 301 may indicate that two groups are activated. In addition, the base station 301 may set beam group indexes (i.e. beam group index #1 and beam group index #2) in a beam group information field 864a of the second type of beam DTX group control information 860.

The base station 301 may configure the second type of beam DTX group control information 860 including one or more beam group-selected beam information fields each including a beam group index and beam information. In FIG. 8B, since two beam groups are selected, beam group-selected beam information fields 864b and 864c for two beam groups may be included.

According to the example of FIG. 8B, the base station 301 may select beam(s) from the beam group #1 331, to which the beam DTX time domain information #1 814 included in (or associated with) the beam group information #1 810 is applied, and may select beam(s) from the beam group #2 332, to which the beam DTX time domain information #2 824 included in (or associated with) the beam group information #2 820 is applied. According to the example of FIG. 8B, the beam #1 321 may be selected from the beam group #1 331, and the beam #2 322 and beam #3 323 may be selected from the beam group #2 332. In other words, the base station 301 may set the beam group index #1 and the beam index #1 in the first beam group-selected beam information field 864b of the second type of beam DTX group control information 860, and may set the beam group index #2, the beam index #2, and the beam index #3 in the second beam group-selected beam information field 864c.

The base station 301 may indicate in the first beam group-selected beam information field 864b that the beam #1 321 belonging to the beam group #1 331 performs beam DTX based on the beam DTX time domain information #1 814. In other words, it may mean that among the beam #1 321 and the beam #2 322 included in the beam group #1 331, only the beam #1 321 performs transmission or stops transmission of the beam based on at least one of TAP, TNP, BCD, or BDSP according to the configuration of beam DTX time domain information #1 814.

Similarly, based on the configuration of the second beam group-selected beam information field 864c, the base station 301 may perform beam DTX for the beam #2 322 and the beam #3 323 belonging to the beam group #2 332 based on the configuration information of beam DTX time domain information #2 824. In other words, the base station 301 may perform transmission or stop transmission of the beam #2 322 and the beam #3 323 based on TAP, TNP, BCD, and BDSP according to the configuration of beam DTX time domain information #2 824.

In steps S432 and S434, the base station 301 may transmit DCI scrambled with the CBG-RNTI 801 in advance through all beams or beams for which beam DTX activation is to be indicated, in order to transmit the second type of beam DTX group control information 860. The DCI transmitted by the base station 301 may indicate reception of a PDSCH on which the second type of beam DTX group control information 860 is transmitted. The base station 301 may transmit the second type of beam DTX group control information 860 to UEs through a resource indicated by the DCI.

Each of the UEs 311 to 315 may monitor a PDCCH and may de-scramble a signal received from the PDCCH using the CBG-RNTI 801. When the DCI is obtained as a result of descrambling using the CBG-RNTI 801, the UE (or UEs) that obtains the DCI may receive the second type of beam DTX group control information 860 through a PDSCH indicated by the DCI.

In steps S433 and S435, the UE (or UEs) that receive the second type of beam DTX group control information 860 may identify whether beam DTX activation for a beam group to which its beam communicating with the base station 301 belongs is indicated. When beam DTX activation for the beam group to which a beam of the UE belongs is indicated, and beam DTX is further indicated by the beam group-selected beam information field 864b or 864c for a beam received from the base station 301 in the corresponding group, the UE(s) may be configured to perform reception operations based on the beam DTX time domain information included in the beam DTX configuration information.

In step S440, the UE #1 311 that receives DL wireless signals from the base station 301 through the beams 321 and 322 included in the beam group #1 331 may receive DL wireless signals from the base station based on at least one of TAP, TNP, BCD, or BDSP included in the beam DTX time domain information #1 814, and in step S442, the UE #2 312 and UE #3 313 that receive DL wireless signals from the base station 301 through the beams 322, 323, and 324 included in the beam group #2 332 may receive DL wireless signals from the base station based on at least one of TAP, TNP, BCD, or BDSP included in the beam DTX time domain information #2 824.

Since the procedure and method in which the UE receives DL wireless signals from the base station 301 based on at least one of TAP, TNP, BCD, or BDSP have already been described with reference to FIG. 5, a redundant description is omitted.

The second type of beam DTX group control information 860 described above may clearly indicate the UE #2 312 included in both the beam group #1 331 and the beam group #2 332 which beam DTX time domain information should be used, unlike the first type of beam DTX group control information 850 described in FIG. 8A. In addition, the second type of beam DTX group control information may exclude application of beam DTX to one or more beams among beams included in a specific group (e.g. the beam #4 324 in the beam group #2 332).

### Usage Example #3 of a Combination of Beam DTX Group Configuration Information and Beam DTX Group Control Information

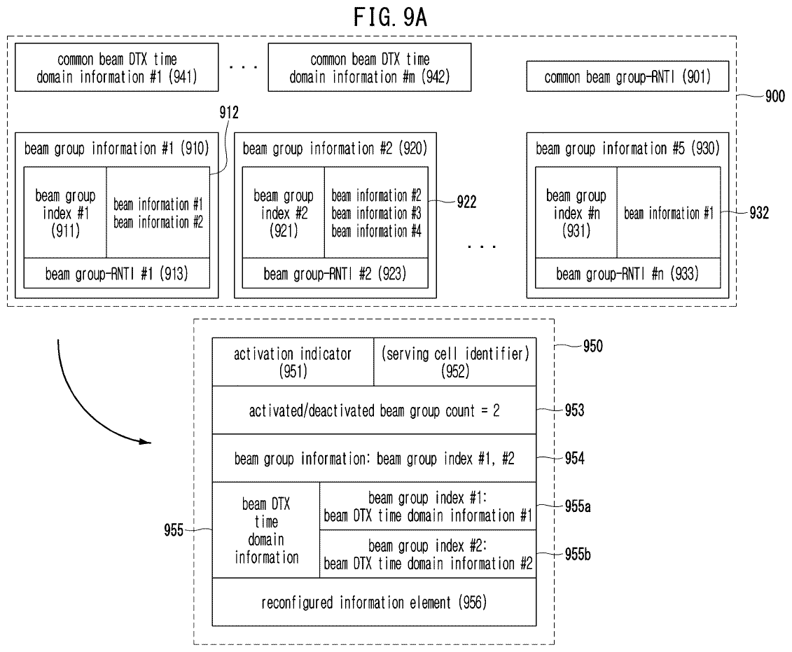

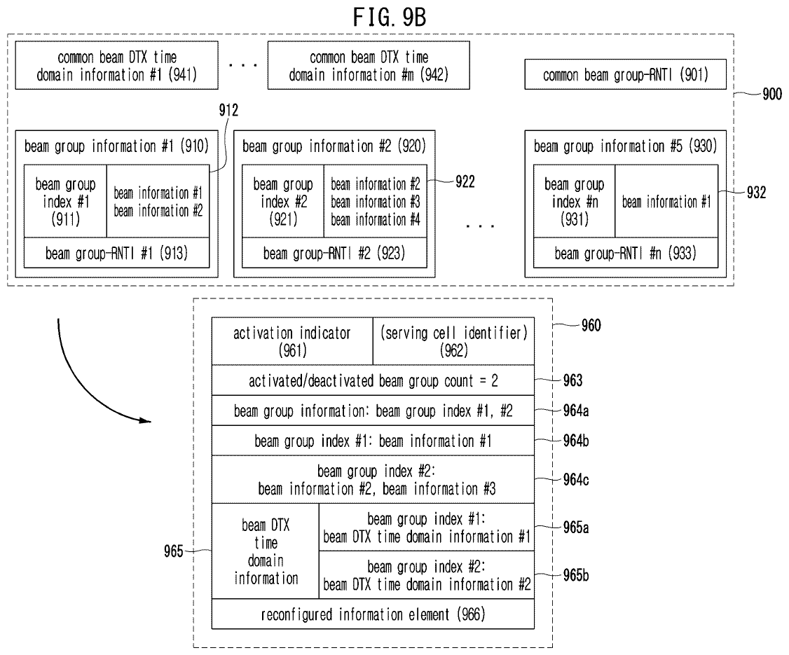

FIG. 9A is a conceptual diagram illustrating a third exemplary embodiment of an activation procedure of a specific beam group by using beam DTX group configuration information and beam DTX group control information.

In step S410, the base station 301 may generate beam DTX group configuration information (BeamDtxGroupConfig) 900. The beam DTX group configuration information 900 illustrated in FIG. 9A may be the second type of beam DTX group configuration information described in FIG. 6B.

The beam DTX group configuration information 900 may include a CBG-RNTI 901 and m pieces of beam DTX time domain information 941, . . . , and 942. In addition, when the base station 301 has four beam groups 331 to 334 as illustrated in FIG. 3, the beam DTX group configuration information 900 may include beam group information 910, 920, . . . , and 930 respectively corresponding to the four beam groups. In FIG. 9A, only the beam group information 910, 920, and 930 for three of the four beam groups are illustrated, and it should be noted that the beam group information for the beam group #3 333 is omitted.

The beam group information #1 910 may include information on the beam group #1 331 illustrated in FIG. 3. For example, the beam group information #1 910 may include a beam group index #1 911 and beam information 912 on the beam group #1 331. More specifically, the beam information 912 on the beam group #1 331 may include beam information #1 on the beam #1 321 included in the beam group #1 331 and beam information #2 on the beam #2 322 included in the beam group #1 331. The beam information #1 and the beam information #2 may each include at least one of a beam index, RS information, or TCI for the corresponding beam. In the case of the beam information #1, the beam index may be beam index #1, and in the case of the beam information #2, the beam index may be beam index #2.

In addition, the beam group information #1 910 may include a beam group-RNTI #1 913. The beam group-RNTI #1 913 may be an identifier for transmitting control information (or, signal or message) of the beam group #1 331 to UE(s) that receive DL wireless signals through beams included in the beam group #1 331.

The beam group information #2 920 may include information on the beam group #2 332 illustrated in FIG. 3. For example, the beam group information #2 920 may include a beam group index #2 921, beam information #2 on the beam #2 322 included in the beam group #2 332, beam information #3 on the beam #3 323 included in the beam group #2 332, and beam information #4 on the beam #4 324 included in the beam group #2 332. The beam information #2, the beam information #3, and the beam information #4 may each include at least one of a beam index, RS information, or TCI for the corresponding beam. In the case of the beam information #2, the beam index may be beam index #2; in the case of the beam information #3, the beam index may be beam index #3; and in the case of the beam information #4, the beam index may be beam index #4.

The beam group information #2 920 may include a beam group-RNTI #2 923. The beam group-RNTI #2 923 may be an identifier for transmitting control information (or, signal or message) of the beam group #2 332 to UE(s) that receive DL wireless signals through beams included in the beam group #2 920.

It should be noted that, unlike FIGS. 8A and 8B described above, the second type of beam DTX group configuration information does not include (or is not associated with) beam DTX time domain information in beam group information.

In step S412, the base station 301 may transmit (broadcast, multicast, or unicast) the beam DTX group configuration information 900 to UEs through all beams. Therefore, UEs 311 to 315 belonging to the base station 301 may receive the beam DTX group configuration information 900 in step S412.

In steps S421 to S424, each of the UEs 311 to 315 that receive the beam DTX group configuration information 900 may monitor control messages through beams received from the base station 301. For example, each of the UEs 311 to 315 may monitor reception of the beam DTX group control information by using a beam group-RNTI included in the beam group information through a beam with which the UE communicates. In addition, each of the UEs 311 to 315 may monitor reception of the beam DTX group control information by using the CBG-RNTI 901. As described above, the monitoring operation of the UE may refer to an operation of obtaining DCI by descrambling a signal received through a PDCCH by using a specific RNTI (e.g. the beam group-RNTI included in the beam group information or the CBG-RNTI).

In the following description, it is assumed that each of the UEs 311 to 315 monitors reception of the beam DTX group control information by using the CBG-RNTI 901.

In step S430, the base station 301 may determine a beam group for which beam DTX is to be activated. The example of FIG. 9A corresponds to a case in which beam DTX activation is indicated for beams of the beam group #1 and the beam group #2. The base station 301 may generate beam DTX group control information (BeamDtxGroupControl) 950 indicating activation of the beam group #1 and the beam group #2. The beam DTX group control information illustrated in FIG. 9A may be the second type of beam DTX group control information described in FIG. 7B, and may be in a form excluding the beam DTX time domain information field and the reconfigured information element field described in FIG. 7B.

In configuring the second type of beam DTX group control information 950, the base station 301 may set an activation/deactivation field 951 to an activation indication. In addition, when one or more UEs communicating in the corresponding beam group have a plurality of serving cells, the base station 301 may set a serving cell identifier in a serving cell identifier field 952. In another example, the base station 301 may unconditionally set a serving cell identifier in the serving cell identifier field 952.

By setting a value of 2 in an activated/deactivated beam group count field 953 in the second type of beam DTX group control information 950, the base station 301 may indicate that two groups are activated. In addition, the base station 301 may set beam group indexes (i.e. beam group index #1 and beam group index #2) in a beam group information field 954a in the second type of beam DTX group control information 950.

The second type of beam DTX group control information 950 may include a beam DTX time domain information indication field 950 indicating that beam DTX time domain information corresponding to a beam group index is transmitted. Since the example of FIG. 9A corresponds to a case in which two beam groups are selected, the second type of beam DTX group control information 950 may include beam DTX time domain indication subfields 955a and 955b respectively corresponding to the two beam groups. According to the example of FIG. 9A, the first subfield 955a may correspond to a case in which beam DTX time domain information #1 to be used for the beam group index #1 is selected, and the second subfield 955b may correspond to a case in which beam DTX time domain information #2 to be used for the beam group index #2 is selected. At least one of the TAP, TNP, BCD, or BDSP values in the beam DTX time domain information #1 may differ from those in the beam DTX time domain information #2.

In addition, the base station 301 may additionally configure a reconfigured information element field 956 in the second type of beam DTX group control information 950. The reconfigured information element field 956 may be information for changing a configuration as to which beam DTX time domain information is to be used by the UE #2 312 included in both the first beam group 331 and the second beam group 332.

In steps S432 and S434, the base station 301 may transmit DCI scrambled with the CBG-RNTI 901 through all beams or through beams for which beam DTX activation is to be indicated. The DCI may indicate reception of a PDSCH on which the second type of beam DTX group control information 950 is transmitted. The base station 301 may transmit the second type of beam DTX group control information 950 to UEs through a resource indicated by the DCI.

Each of the UEs 311 to 315 may monitor a PDCCH and may descramble a signal received from the PDCCH using the CBG-RNTI 901. When the DCI is obtained as a result of descrambling using the CBG-RNTI 901, UE(s) that obtain the DCI may receive the second type of beam DTX group control information 950 through a PDSCH indicated by the DCI.

In steps S433 and S435, UE(s) that receive the second type of beam DTX group control information 950 may identify whether beam DTX activation of a beam group to which its beam communicating with the base station 301 belongs is indicated. When beam DTX activation is indicated for the beam group to which its beam communicating with the base station 301 belongs, the UE(s) may be configured to perform a reception operation according to beam DTX based on the beam DTX time domain information of the second type of beam DTX group control information 950. In addition, when DL wireless signals are received through the beam #2 322 included in both the first beam group 331 and the second beam group 332 as in the UE #2 312, the beam DTX time domain information may be determined by an indication of the reconfigured information element field 956.

In step S440, the UE #1 311 and the UE #2 312 may determine the beam DTX time domain information #1 914 based on the first subfield 955a that provides mapping information between beam groups and beam DTX time domain information. Accordingly, the UE #1 311 and the UE #2 312 may receive DL wireless signals from the base station based on at least one of TAP, TNP, BCD, or BDSP included in the beam DTX time domain information #1 941. In step S442, the UE #2 312, UE #3 313, and UE #4 314 may receive DL wireless signals from the base station based on at least one of TAP, TNP, BCD, or BDSP included in the beam DTX time domain information #2 942. In other words, the base station 301 may perform DTX for the DL wireless signals. Therefore, the UE may monitor (or attempt to receive) DL wireless signals, or stop monitoring (or stop attempting to receive) DL wireless signals in accordance with the base station 301 performing DTX for the DL wireless signals.

Since the procedure and method in which the UE receives DL wireless signals from the base station 301 based on at least one of TAP, TNP, BCD, or BDSP have already been described with reference to FIG. 5, a redundant description is omitted.

Meanwhile, a beam deactivation indication may be a procedure in which the activation/deactivation indication field 951 of the beam DTX group control information 950 illustrated in FIG. 9A is transmitted with its value set to a deactivation indication. Since other fields and operations thereof may be understood as in the procedures according to the activation indication, a description on the procedures according to the deactivation indication is omitted.

### Usage Example #4 of a Combination of Beam DTX Group Configuration Information and Beam DTX Group Control Information

FIG. 9B is a conceptual diagram illustrating a fourth exemplary embodiment of an activation procedure of a specific beam group using beam DTX group configuration information and beam DTX group control information.

In step S410, the base station 301 may generate beam DTX group configuration information 900, and in step S412, the generated beam DTX group configuration information 900 may be transmitted (broadcasted, multicast, or unicast) to UEs through all beams. Accordingly, the UEs 311 to 315 belonging to the base station 301 may receive the beam DTX group configuration information 900 in step S412.

The beam DTX group configuration information 900 in FIG. 9B may have the same configuration as described in FIG. 9A. Therefore, for simplicity, the detailed configuration of the beam DTX group configuration information 900 is omitted in FIG. 9B, and it should be noted that the beam DTX group configuration information 900 has the same configuration as FIG. 9A. In other words, the beam DTX group configuration information 900 may be the second type of beam DTX group configuration information as described in FIG. 6B.

In steps S421 to S424, the UE #1 311, UE #2 312, UE #3 313, UE #4 314, and UE #5 315 may monitor control messages through beams received from the base station 301. As described in FIG. 9A, it is assumed that each of the UEs 311 to 315 performs monitoring of beam DTX group control information using a CBG-RNTI 901.

In step S430, the base station 301 may determine a beam group for which beam DTX is to be activated. The example of FIG. 9B may correspond to a case of assuming that the beam DTX activation is indicated for beams of the beam group #1 and the beam group #2, as described earlier in FIG. 9A. The base station 301 may generate beam DTX group control information (BeamDtxGroupControl) 960 indicating beam DTX activation of the beam group #1 and the beam group #2. The beam DTX group control information illustrated in FIG. 9B may be the second type of beam DTX group control information as described earlier in FIG. 7B, and may be in a form including both the beam DTX time domain information field and the reconfiguration information element field described in FIG. 7B.

In configuring the second type of beam DTX group control information 960, the base station 301 may set an activation/deactivation field 961 to an activation indication, and when at least one UE communicating in the corresponding beam group has a plurality of serving cells, a serving cell identifier may be set in a serving cell identifier field 962. In another example, the base station 301 may unconditionally set a serving cell identifier in the serving cell identifier field 962. If a serving cell identifier is not included in the serving cell identifier field 962, the corresponding field may be padded with zero bits.

By setting a value of 2 in an activated/deactivated beam group count field 963 in the second type of beam DTX group control information 960, the base station 301 may indicate that two groups are activated. The base station 301 may set beam group indexes (i.e. beam group index #1 and beam group index #2) in a beam group information field 964a in the second type of beam DTX group control information 960.

The base station 301 may configure the second type of beam DTX group control information 960 including one or more beam group-selected beam information fields each including a beam group index and beam information. Since two beam groups are selected in FIG. 9B, two beam group-selected beam information fields 964b and 964c may be included. According to the example of FIG. 9B, the first beam group-selected beam information field 964b may correspond to a case in which beam information #1 indicating the beam #1 321 in the beam group index #1 is configured, and the second beam group-selected beam information field 964c may correspond to a case in which beam information #2 and beam information #3 respectively indicating the beam #2 322 and the beam #3 323 in the beam group index #2 are configured.

The base station 301 may select beam(s) to which beam DTX is applied in the first beam group 331, and may select beam(s) to which beam DTX is applied in the second beam group 332. According to the example of FIG. 9B, the base station 301 may select the beam #1 321 from the beam group #1 331 and the beam #2 322 and beam #3 323 from the beam group #2 332. In other words, the base station 301 may set beam group index #1 and beam index #1 in the first beam group-selected beam information field 964b of the second type of beam DTX group control information 960, and may set beam group index #2, beam index #2, and beam index #3 in the second beam group-selected beam information field 964c.

The second type of beam DTX group control information 960 may include a beam DTX time domain information indication field 965 indicating that beam DTX time domain information for a beam group index is transmitted. Since two beam groups are selected in the example of FIG. 9B, the second type of beam DTX group control information 960 may include beam DTX time domain indication subfields 965a and 965b respectively corresponding to the two beam groups. According to the example of FIG. 9B, the first subfield 965a may correspond to a case where beam DTX time domain information #1 to be used in the beam group index #1 is selected, and the second subfield 955b may correspond to a case where beam DTX time domain information #2 to be used in the beam group index #2 is selected. At least one value among TAP, TNP, BCD, or BDSP of the beam DTX time domain information #1 may be different from at least one value among TAP, TNP, BCD, or BDSP of the beam DTX time domain information #2.

In addition, the base station 301 may further configure a reconfigured information element field 956 in the second type of beam DTX group control information 960.

In steps S432 and S434, the base station 301 may transmit DCI scrambled with the CBG-RNTI 901 through all beams or beams for which beam DTX activation is to be indicated. The DCI may indicate reception of a PDSCH on which the second type of beam DTX group control information 960 is transmitted. The base station 301 may transmit the second type of beam DTX group control information 960 to UEs through a resource indicated by the DCI.

Each of the UEs 311 to 315 may monitor a PDCCH and may de-scramble a signal received from the PDCCH using the CBG-RNTI 901. If DCI is obtained as a result of de-scrambling using the CBG-RNTI 901, UE(s) that obtain the DCI may receive the second type of beam DTX group control information 960 through a PDSCH indicated by the DCI.

In steps S433 and S435, UE(s) that receive the second type of beam DTX group control information 950 may identify whether beam DTX activation is indicated for a beam group to which its beam communicating with the base station 301 belongs. If the beam DTX activation is indicated for the beam group to which its beam communicating with the base station 301 belongs, the UE may identify whether the beam DTX activation is indicated for its beam communicating with the base station 301 through the beam group-selected beam information fields 964b and 964c in the second type of beam DTX group control information 960. If the beam DTX activation is indicated for the beam communicating with the base station 301, the UE may be configured to perform a reception operation according to the beam DTX based on the beam DTX time domain information.

In addition, the base station 301 may indicate to the UE #2 312, which receives DL wireless signals through beam #2 322 included in both the first beam group 331 and the second beam group 332, in which beam index group it should operate by using the beam group-selected beam information fields 964b and 964c.

In step S440, the UE #1 311 may determine beam DTX time domain information #1 914 based on the first subfield 955a providing mapping information between beam groups and beam DTX time domain information. Accordingly, the UE #1 311 may receive DL wireless signals from the base station based on at least one of TAP, TNP, BCD, or BDSP included in the beam DTX time domain information #1 914. In other words, the base station 301 may perform DTX for DL wireless signals. Therefore, the UE may monitor (or attempt to receive) DL wireless signals, or stop monitoring (or stop attempting to receive) DL wireless signals in accordance with the base station 301 performing DTX for DL wireless signals.

In step S442, the UE #2 312 and the UE #3 313 may receive DL wireless signals from the base station based on at least one of TAP, TNP, BCD, or BDSP included in the beam DTX time domain information #2 942.

Since the procedure and method in which the UE receives DL wireless signals from the base station 301 based on at least one of TAP, TNP, BCD, or BDSP have already been described with reference to FIG. 5, a redundant description is omitted.

Meanwhile, a beam deactivation indication may be a procedure in which the activation/deactivation indication field 951 of the beam DTX group control information 950 illustrated in FIG. 9B is transmitted with its value set to a deactivation indication. Since other fields and operations thereof may be understood as in the procedures according to the activation indication, a description on the procedures according to the deactivation indication is omitted.

The four usage examples described above are examples according to mapping relationships between the first type of beam DTX group configuration information, the second type of beam DTX group configuration information, the first type of beam DTX group control information, and the second type of beam DTX group control information.

In addition, the third type of beam DTX group configuration information and the fourth type of beam DTX group configuration information may also be used together with the first type of beam DTX group control information and the second type of beam DTX group control information.

The operations of the method according to the exemplary embodiment of the present disclosure can be implemented as a computer readable program or code in a computer readable recording medium. The computer readable recording medium may include all kinds of recording apparatus for storing data which can be read by a computer system. Furthermore, the computer readable recording medium may store and execute programs or codes which can be distributed in computer systems connected through a network and read through computers in a distributed manner.

The computer readable recording medium may include a hardware apparatus which is specifically configured to store and execute a program command, such as a ROM, RAM or flash memory. The program command may include not only machine language codes created by a compiler, but also high-level language codes which can be executed by a computer using an interpreter.

Although some aspects of the present disclosure have been described in the context of the apparatus, the aspects may indicate the corresponding descriptions according to the method, and the blocks or apparatus may correspond to the steps of the method or the features of the steps. Similarly, the aspects described in the context of the method may be expressed as the features of the corresponding blocks or items or the corresponding apparatus. Some or all of the steps of the method may be executed by (or using) a hardware apparatus such as a microprocessor, a programmable computer or an electronic circuit. In some embodiments, one or more of the most important steps of the method may be executed by such an apparatus.

In some exemplary embodiments, a programmable logic device such as a field-programmable gate array may be used to perform some or all of functions of the methods described herein. In some exemplary embodiments, the field-programmable gate array may be operated with a microprocessor to perform one of the methods described herein. In general, the methods are preferably performed by a certain hardware device.

The description of the disclosure is merely exemplary in nature and, thus, variations that do not depart from the substance of the disclosure are intended to be within the scope of the disclosure. Such variations are not to be regarded as a departure from the spirit and scope of the disclosure. Thus, it will be understood by those of ordinary skill in the art that various changes in form and details may be made without departing from the spirit and scope as defined by the following claims.

What is claimed is:

1. A method of a user equipment (UE), comprising:
receiving beam discontinuous transmission (DTX) group configuration information from a base station through a first beam or a second beam;
monitoring reception of first beam DTX group control information indicating beam DTX activation for at least one beam of the first beam or the second beam based on the beam DTX group configuration information;
determining whether beam DTX activation for the first beam is indicated based on reception of the first beam DTX group control information; and
performing discontinuous reception of downlink (DL) wireless signals from the base station through the first beam, based on the beam DTX activation being indicated for the first beam,
wherein the DL wireless signals include at least one of: a first physical downlink control channel (PDCCH), a first physical downlink shared channel (PDSCH), a reference signal (RS), or a synchronization signal (SS).

2. The method of claim 1, wherein the beam DTX group configuration information includes at least one of: beam group information for each of one or more beam groups, a common beam group-radio network temporary identifier (RNTI) for all beam groups, a beam group-RNTI for each of the one or more beam groups, or beam DTX time domain information.

3. The method of claim 2, wherein the beam DTX activation for the first beam is indicated by downlink control information (DCI) scrambled with one of the common beam group-RNTI or a beam group-RNTI corresponding to a beam group including the first beam.

4. The method of claim 2, wherein the beam DTX activation for the first beam is indicated through a second PDSCH indicated by DCI received through a second PDCCH, and the DCI is received by being scrambled with one of the common beam-group RNTI or a beam group-RNTI corresponding to a beam group including the first beam.

5. The method of claim 2, wherein a case in which the beam DTX activation for the first beam is indicated corresponds to a case in which the first beam DTX group control information indicates activation of a first beam group including the first beam, the first beam group being configured by the beam DTX group configuration information.

6. The method of claim 2, wherein a case in which the beam DTX activation for the first beam is indicated corresponds to a case in which the first beam DTX group control information indicates activation for a first beam group including the first beam, and an identifier of the first beam is included in first beam group information on the first beam group included in the first beam DTX group control information, the first beam group being configured by the beam DTX group configuration information.

7. The method of claim 2, wherein the beam DTX time domain information is configured for each of the one or more beam groups or configured to be commonly applied to all beam groups, and the beam DTX time domain information includes at least one of: a transmission active period (TAP) in which DL wireless signals are transmitted through a beam for which beam DTX activation is indicated, a transmission non-active period (TNP) in which transmission of DL wireless signals through a beam for which beam DTX activation is indicated is stopped, a beam DTX cycle (BDC) in which the TAP and the TNP are repeated, or a beam DTX service period (BDSP) in which the BDC is repeated.

8. The method of claim 1, wherein the first beam DTX group control information includes at least one of: whether to activate or deactivate beam DTX, a serving cell identifier, a number of beam groups, an indicator of beam DTX time domain information to be activated, information on one or more beam groups to perform beam DTX activation/deactivation, beam information to indicate one or more beams among beams included in each of the one or more beam groups to perform beam DTX activation/deactivation, or one or more information elements to be reconfigured among information elements included in the beam DTX group configuration information.

9. The method of claim 1, further comprising:
monitoring reception of second beam DTX group control information from the base station;
determining whether beam DTX deactivation for the first beam is indicated based on reception of the second beam DTX group control information; and
releasing a reception operation of DL wireless signals from the base station according to beam DTX through the first beam based on the beam DTX deactivation being indicated for the first beam.

10. The method of claim 9, wherein the beam DTX deactivation for the first beam is indicated by DCI scrambled with one of a common beam group-RNTI or a beam group-RNTI corresponding to a beam group including the first beam.

11. The method of claim 9, wherein the beam DTX deactivation for the first beam is indicated through a second PDSCH indicated by DCI received through a second PDCCH, and the DCI is received by being scrambled with one of a common beam group-RNTI or a beam group-RNTI corresponding to a beam group including the first beam.

12. A method of a base station, comprising:
transmitting beam discontinuous transmission (DTX) group configuration information for a plurality of beams to a user equipment (UE);
based on beam DTX being required for one or more beam groups, transmitting, to the UE, first beam DTX group control information for controlling beam DTX activation based on the beam DTX group configuration information, each beam group including one or more beams among the plurality of beams; and
performing discontinuous transmission of downlink (DL) wireless signals through each beam for which beam DTX is indicated by the first beam DTX group control information, based on the beam DTX group configuration information,
wherein the beam DTX group configuration information includes at least one of: beam group information for each of the one or more beam groups, a common beam group-radio network temporary identifier (RNTI) for all beam groups, a beam group-RNTI for each of the one or more beam groups, or beam DTX time domain information, and
wherein the DL wireless signals include at least one of: a first physical downlink control channel (PDCCH), a first physical downlink shared channel (PDSCH), a reference signal (RS), or a synchronization signal (SS).

13. The method of claim 12, wherein the beam group information for each of the one or more beam groups includes at least one of: beam information for one or more beams, a beam group index, or a beam group-RNTI, and the beam information includes at least one of: a beam identifier (ID) for distinguishing a beam, information on a reference signal (RS) specifying the beam, or transmission configuration indicator (TCI) information representing channel characteristics of the beam.

14. The method of claim 12,
wherein the beam DTX time domain information is configured for each of the one or more beam groups or configured to be commonly applied to all beam groups, and the beam DTX time domain information includes at least one of: a transmission active period (TAP) in which DL wireless signals are transmitted through a beam for which beam DTX activation is indicated, a transmission non-active period (TNP) in which transmission of DL wireless signals through a beam for which beam DTX activation is indicated is stopped, a beam DTX cycle (BDC) in which the TAP and the TNP are repeated, or a beam DTX service period (BDSP) in which the BDC is repeated, and
wherein the first beam DTX group control information includes an indicator of beam DTX time domain information to be applied to each of the one or more beam groups or a beam for which beam DTX activation is indicated, or information elements to be reconfigured among information elements included in the beam DTX group configuration information.

15. The method of claim 12, wherein the first beam DTX group control information for controlling the beam DTX activation is transmitted to the UE through downlink control information (DCI), and the DCI is scrambled with one of the common beam-group RNTI or the beam group-RNTI.

16. The method of claim 12, wherein the first beam DTX group control information for controlling the beam DTX activation is transmitted to the UE through a second PDSCH indicated by DCI, and the DCI is scrambled with one of the common beam group-RNTI or the beam group-RNTI and transmitted to the UE through a second PDCCH.

17. The method of claim 12, wherein the first beam DTX group control information includes at least one of: a serving cell identifier, a number of activated beam groups, information of one or more activated beam groups to perform beam DTX activation, an indicator of beam DTX time domain information, information on beam(s) to perform beam DTX activation among beams included in a beam group to be activated, or one or more information elements to be reconfigured among information elements included in the beam DTX group configuration information.

18. The method of claim 12, wherein a case in which beam DTX is required for the one or more beam groups corresponds to a case of requiring at least one of energy saving of the base station, energy saving of the UE, reduction in a number of UEs in communication, reduction of traffic load, reduction of beam transmission load, or interference control with a neighbor beam.

19. A user equipment (UE) comprising at least one processor, wherein the at least one processor causes the UE to perform:
receiving beam discontinuous transmission (DTX) group configuration information from a base station through a first beam or a second beam;
monitoring reception of first beam DTX group control information indicating beam DTX activation for at least one beam of the first beam or the second beam based on the beam DTX group configuration information;
determining whether beam DTX activation for the first beam is indicated based on reception of the first beam DTX group control information; and
performing discontinuous reception of downlink (DL) wireless signals from the base station through the first beam, based on the beam DTX activation being indicated for the first beam,
wherein the DL wireless signals include at least one of: a first physical downlink control channel (PDCCH), a first physical downlink shared channel (PDSCH), a reference signal (RS), or a synchronization signal (SS).

20. The UE of claim 19, wherein the beam DTX group configuration information includes at least one of: beam group information for each of one or more beam groups, a common beam group-radio network temporary identifier (RNTI) for all beam groups, a beam group-RNTI for each of the one or more beam groups, or beam DTX time domain information.
